(19) United States
(12) Patent Application Publication
(10) Pub. No.: US 2025/0230087 A1
(43) Pub. Date: Jul. 17, 2025

(54) FINING OF SUBMERGED COMBUSTION OR OTHER GLASS

(71) Applicant: Owens-Brockway Glass Container Inc., Perrysburg, OH (US)

(72) Inventors: Zhongming Wang, Ypsilanti, MI (US); Matthew Butz, Perrysburg, OH (US); Eduardo Loayza, Lima (PE); Nolan Foster, Whitehouse, OH (US)

(21) Appl. No.: 18/412,356

(22) Filed: Jan. 12, 2024

(51) Int. Cl. C03B 5/225; C03B 5/235; C03B 5/26

(52) U.S. Cl. CPC C03B 5/2252; C03B 5/2356; C03B 5/26

(57) ABSTRACT

A glass-producing system is disclosed that includes a glass melter and a glass fining tower positioned downstream of the glass melter. The glass fining tower includes a shell, a tubular wall disposed within and surrounded by the shell, and a base receiving wall that extends inwardly from the shell to the tubular wall. The tubular wall and the base receiving wall provide an interior fining chamber within the shell. The interior fining chamber comprises an elongated vertical well that is defined by the tubular wall and has an opening that is at least partially surrounded by a glass distribution surface of the base receiving wall. The glass fining tower further includes a heater and a vacuum source operable to maintain the interior fining chamber at a subatmospheric pressure. A method of producing glass is also disclosed.

The present disclosure is directed to glass manufacturing and, more specifically, to techniques for producing glass using a submerged combustion melter or some other melting device that produces comparatively foamy molten glass and, thereafter, fining the glass.

### BACKGROUND

Glass is a rigid amorphous solid that exhibits a disordered (i.e., no long-range order) and spatially crosslinked oxide network. To manufacture glass, a vitrifiable feedstock material is heated to melt-react the various ingredients of the feedstock material into a flowable glassy melt having the glass chemistry needed for downstream processing into finished glass articles. The vitrifiable feedstock material typically includes glass forming ingredients along with glass network modifying ingredients and other secondary ingredients that affect glass color, glass redox, and the finability of the glass. Glasses such as soda-lime-silica glass, for example, include SiO₂ as the primary glass former. These glasses have widespread commercial applications including the manufacture of flat glass products and hollow glass containers. For soda-lime-silica glass, the vitrifiable feedstock material may include virgin raw materials such as quartz sand, soda ash, and limestone, and may further include recycled glass (i.e., cullet), glass precursor oxides in solid, liquid, or gel form, plus others not mentioned. The various materials are incorporated into the vitrifiable feedstock material in the proportions needed to produce glass with a certain chemistry and appearance.

Submerged combustion (SC) melting is a melting technology that has drawn interest as a possible option for commercial glass manufacturing. Contrary to conventional glass melting practices, in which molten glass is heated primarily with radiant heat from overhead burners, SC melting involves injecting a combustible gas mixture that contains a fuel and an oxidant directly into a glass melt contained within a SC melter. The combustible gas mixture is injected though submerged burners mounted in the floor or in an immersed portion of the sidewall of a SC melter housing while the vitrifiable feedstock material is fed into the glass melt. The combustible gas mixture autoignites and the resultant combustion products cause vigorous stirring and turbulence as they are discharged through the glass melt. The intense shearing forces experienced between the combustion products and the glass melt cause rapid heat transfer and particle dissolution throughout the glass melt compared to the slower reaction kinetics of a conventional melting furnace.

While SC melting technology can melt the vitrifiable feedstock material into chemically homogenized molten glass relatively quickly, the direct injection of the combustible gas mixture into the glass melt—and the consequential turbulence that results therefrom—generates substantial quantities of entrained gas bubbles within the glass melt. Indeed, the glass melt produced in a SC melter is generally a volume of low-density and foamy molten glass that can include greater than 20 vol % of entrained gas bubbles. These entrained gas bubbles may need to be removed from the glass downstream of the SC melter to satisfy commercial specifications for “fined” glass depending on the end-use of the glass. The removal of gas bubbles—a process known as “fining”—may be warranted for various reasons including the visual appearance of the glass when cooled and formed into a finished commercial article such as a glass container, flat glass product, or tableware.

The challenges involved in fining molten glass discharged from an SC melter are much different than those involved in fining glass produced in a conventional melting furnace. In one respect, the gas bubbles contained in the glass melt of an SC melter contain different gas species than the bubbles produced in a conventional melting furnace. In SC-produced glass, the entrained gas bubbles include gas species derived from the combustion products that are fired through the glass melt, the volatilization of species out of the glass, and the decomposition of carbonates, whereas the entrained gas bubbles in conventionally-produced molten glass primarily include gas species derived from the decomposition of carbonates and other materials. The entrained gas bubbles in SC-produced glass are also homogeneously distributed throughout the melt at a significantly higher volumetric proportion than in conventionally produced glass. The entrained gas bubbles of SC-produced glass thus have a greater tendency to form an insulating layer of foam on top of the molten glass once the glass is allowed to settle in a downstream structure. The insulating foam layer can block the transfer of heat into the underlying molten glass, which, in turn, can slow the overall fining process by causing a drop in temperature within the deeper portions of the molten glass. Still further, the addition of chemical fining agents into the SC melter is a complex endeavor since the direct firing of combustion gasses through the glass melt can result in excessive volatilization of the fining agents and/or unwanted chemical side reactions.

Considering the operational differences between submerged combustion melting and conventional glass melting, and the impact each of those melting processes has on the resultant glass produced therefrom in terms of bubble generation, it should not be surprising that fining techniques developed for conventionally melted glass may not be well adapted for fining SC-produced glass. In many instances, if conventional fining techniques are employed to fine SC-produced glass, including adding the SC-produced glass into a separate vessel and heating the glass with overhead burners and/or submerged electrodes, the residence time required to adequately fine the glass is too long. Glass fining practices that are more tailored to SC-produced glass are therefore needed to help implement SC glass melting, or some other melting technology that produces comparatively foamy molten glass, in a commercial setting where production standards that specify a certain quality of glass with regards to bubble content need to be consistently met.

### SUMMARY OF THE DISCLOSURE

The present disclosure relates to a glass-producing system that includes at least one glass fining tower that operates at low pressure, is heated, and is configured to fine molten glass through a combination of thin-layer fining, stream fining, and deep gravitational fining. The glass-producing system also includes a glass melter that produces unfined molten glass. The unfined molten glass comprises at least 20 percent by volume of entrained glass bubbles. In that regard, the glass melter may be a submerged combustion melter that includes at least one submerged burner configured to discharge combustion products of a combustible gas mixture of a fuel and an oxidant directly into and through a glass melt. The glass fining tower is positioned downstream of the glass melter relative to a flow direction of glass through the glass-producing system. The glass fining tower assists in the overall fining process in which entrained gas bubbles are removed from the unfined molten glass produced by the glass melter to form fined molten glass suitable, at least in terms of bubble content, for glass forming operations.

The glass fining tower includes a shell, a tubular wall within and surrounded by the shell that defines an elongated vertical well, and a base receiving wall that extends inwardly from the shell to the tubular wall to provide a glass distribution surface that at least partially surrounds an opening of the elongated vertical well. The tubular wall and the base receiving wall define an interior fining chamber within the shell, of which the elongated vertical well is part, and a perimeter space below the base receiving wall that circumscribes the tubular wall. A heater such as, for example, an induction heater, an electric heater, a microwave heater, or a combustion heater, is operable to introduce heat through the tubular wall and into a column of molten glass contained within the elongated vertical well. Additionally, a vacuum source, such as a vacuum pump, communicates with the interior fining chamber and is operable to reduce a pressure of the interior fining chamber to below atmospheric pressure. The partial vacuum maintained in the interior fining chamber promotes the ascension of gas bubbles upwards through the molten glass within the glass fining tower, making it easier for the bubbles to escape from the glass and burst, and the heater helps ensure that the molten glass column contained within the elongated vertical well maintains a viscosity conducive to continued fining within the well.

In operation, the glass fining tower receives an inflow of molten glass having a concentration of entrained gas bubbles and discharges an outflow of molten glass having a concentration of entrained gas bubbles. The concentration of entrained gas bubbles in the outflow of molten glass is less than the concentration of entrained gas bubbles in the inflow of molten glass. The inflow of molten glass is sourced from an output of unfined molten glass that is discharged from the upstream glass melter; that is, the output of unfined molten glass discharged from the glass melter may be directly introduced into the glass fining tower as the inflow of molten glass or the output of unfined molten glass discharged from the glass melter may be introduced first into a unit positioned between the glass melter and the glass fining tower relative to the flow direction of glass through the glass-producing system and the intervening unit, in turn, discharges an outflow of molten glass that is introduced into the glass fining tower as the inflow of molten glass. In other words, the origination of the glass that comprises the inflow of molten glass, which is introduced into the glass fining tower, can be traced back to the glass melter.

The inflow of molten glass is introduced into the interior fining chamber and is delivered over the glass distribution surface as an overspilling glass layer to spread the glass over a larger surface area. Spreading and thinning the molten glass over the glass distribution surface—a process referred to as “thin-layer fining”—reduces the distance entrained gas bubbles have to ascend through the glass before escaping and bursting as the overspilling glass layer flows towards the elongated vertical well. Thin-layer fining helps speed the overall fining process by decreasing the distance, and thus the time, that bubbles need to rise through the glass. After flowing over the glass distribution surface, the overspilling glass layer spills downwards into the elongated vertical well through the opening of the well and feeds the molten glass column that accumulates in the well. Flowing the overspilling glass layer into the opening of the well—a process referred to as “stream fining”—downwardly alters the flow direction of the overspilling glass layer and, because of that change in flow pattern, helps force more entrained gas bubbles out of the glass. Stream fining also helps speed the overall fining process by providing a glass flow pattern shift to the overspilling glass layer that drives bubbles out of the glass. Once the overspilling glass layer enters the molten glass column within the elongated vertical well, the glass separates gravitationally in the molten glass column in a process referred to as “deep gravitational fining”; that is, higher-density molten glass (which contains a relatively lower bubble count) sinks while the lower-density molten glass (which contains a relatively higher bubble count) rises. By maintaining the pressure of the interior fining chamber at below atmospheric pressure (i.e., a subatmospheric pressure), the rate or velocity of bubble ascension through the overspilling glass layer and the molten glass column is enhanced. Moreover, by heating the molten glass column, the rate or velocity of bubble ascension through the molten glass column is supported by helping ensure that the viscosity of the glass does not increase too significantly.

The outflow of molten glass is pulled or drawn from the molten glass column and is discharged from the glass fining tower. If the concentration of entrained gas bubbles in the outflow of molten glass is low enough to satisfy the standard or specification for fined molten glass, which may depend on the glass article being formed, the outflow of molten glass is considered to be comprised of fined molten glass and may be directed to a thermal conditioning tank where a bath of molten glass is thermally homogenized and brought to a particular glass viscosity that is suitable for glass forming operations. For example, when forming glass containers from soda-lime-silica glass, the molten glass bath that flows within the thermal conditioning tank may be thermally homogenized and brought to a glass viscosity that ranges from 10³ Pa·s to 10² Pa·s, which coincides with a glass temperature that typically ranges from 1050° C. to 1200° C. If, however, the concentration of entrained gas bubbles in the outflow of molten glass is not low enough to satisfy the specification for fined molten glass, the outflow of molten glass may be directed to another fining tank, which may be another glass fining tower of the same general construction. In some instances, two or more glass fining towers may be located downstream of the glass melter, in succession, in order to obtain fined molten glass that can be supplied to a thermal conditioning tank.

The present disclosure embodies a number of aspects that can be implemented separately from or in combination with each other. According to one embodiment of the present disclosure, a glass-producing system includes a glass melter and a glass fining tower positioned downstream of the glass melter relative to a flow direction of glass through the glass-producing system. The glass fining tower comprises a shell, a tubular wall disposed within and surrounded by the shell, and a base receiving wall that extends inwardly from the shell to the tubular wall. The tubular wall and the base receiving wall provide an interior fining chamber within the shell that comprises an elongated vertical well. The elongated vertical well is defined by the tubular wall and has an opening that is at least partially surrounded by a glass distribution surface of the base receiving wall. The glass fining tower further comprises a heater operable to introduce heat through the tubular wall and a vacuum source operable to reduce a pressure of the interior fining chamber to a subatmospheric level.

According to another embodiment of the present disclosure, a glass-producing system includes a glass melter and a glass fining tower. An output of unfined molten glass is discharged from the glass melter and the glass fining tower is positioned downstream of the glass melter relative to a flow direction of glass through the glass-producing system. The glass fining tower includes a shell, a tubular wall, and a base receiving wall. The tubular wall is disposed within and is surrounded by the shell and defines an elongated vertical well that contains a column of molten glass. The base receiving wall extends inwardly from the shell to the tubular wall and provides a glass distribution surface that at least partially surrounds an opening of the elongated vertical well. The base receiving wall and the tubular wall together establish an interior fining chamber within the shell of which the elongated vertical well is part. The fining tower further includes a heater operable to introduce heat into the molten glass column through the tubular wall and a vacuum source that fluidly communicates with a vacuum port defined in the shell and is operable to reduce a pressure of the interior fining chamber to a subatmospheric level. The glass fining tower is configured to deliver an inflow of molten glass onto the base receiving wall so that the inflow of molten glass flows over the glass distribution surface into the elongated vertical well to feed the column of molten glass contained in the elongated vertical well. The glass fining tower is also configured to discharge an outflow of molten glass that is drawn from the column of molten glass contained in the elongated vertical well.

According to still another embodiment of the present disclosure, a method of producing glass includes several steps. One step involves discharging an output of unfined molten glass from a glass melter. The output of unfined molten glass comprises at least 20 vol % of entrained gas bubbles. Another step of the method involves introducing an inflow of molten glass, which is sourced from the output of unfined molten glass discharged from the glass melter, into a glass fining tower. The glass fining tower includes a shell, a tubular wall disposed within and surrounded by the shell, and a base receiving wall that extends inwardly from the shell to the tubular wall. The tubular wall and the base receiving wall provide an interior fining chamber within the shell. The tubular wall defines an elongated vertical well, which is part of the interior fining chamber and contains a column of molten glass, and the base receiving wall provides a glass distribution surface that at least partially surrounds an opening of the elongated vertical well. Still another step of the method involves delivering the inflow of molten glass onto the base receiving wall and flowing the inflow of molten glass over the glass distribution surface of the base receiving wall as an overspilling glass layer that falls into the elongated vertical well and combines with the column of molten glass. Yet another step of the method involves maintaining a subatmospheric pressure within the interior fining chamber of the glass fining tower. Still another step of the method involves introducing heat into the molten glass column contained within the elongated vertical well through the tubular wall. Another step of the method involves discharging an outflow of molten glass, which is drawn from the column of molten glass contained within the elongated vertical well, from the glass fining tower. The outflow of molten glass has a concentration of entrained gas bubbles that is lower than a concentration of entrained gas bubbles of the inflow of molten glass.

### BRIEF DESCRIPTION OF THE DRAWINGS

FIG. 1 is an elevated cross-sectional representation of a portion of a glass-producing system that includes a glass melter, a glass prefining vessel located beneath the glass melter, a glass fining tower, and a thermal conditioning tank (not shown) according to one embodiment of the present disclosure;

FIG. 2 is an elevated cross-sectional view of the glass melter, in the form of a submerged combustion melter, and the glass prefining vessel illustrated in FIG. 1 according to one embodiment of the present disclosure;

FIG. 2A is a magnified view of the housing of the submerged combustion melter illustrated in FIG. 1 according to one embodiment of the present disclosure;

FIG. 3 is a cross-sectional view of the glass fining tower illustrated in FIG. 1 according to one embodiment of the present disclosure;

FIG. 4 is an elevated cross-sectional view of the thermal conditioning tank included in the glass-producing system of FIG. 1 according to one embodiment of the present disclosure;

FIG. 5 is a flow-chart illustrating a method by which conditioned molten glass may be formed into glass containers according to one embodiment of the present disclosure;

FIG. 6 is an elevated cross-sectional view of a submerged combustion melter and a glass prefining vessel of the glass-producing system according to another embodiment of the present disclosure;

FIG. 7 is an elevated cross-sectional view of a glass-producing system that includes a glass melter, a glass prefining vessel, an intermediate fining reservoir located in a glass transfer conduit, a glass fining tower, and a thermal conditioning tank (not shown) according to still another embodiment of the present disclosure;

FIG. 8 is an elevated cross-sectional view of a glass-producing system that includes a glass melter, a glass prefining vessel, a first glass fining tower, a second glass fining tower, and a thermal conditioning tank (not shown) according to yet another embodiment of the present disclosure;

FIG. 9 is an elevated cross-sectional view of a glass-producing system that includes a glass melter and a glass fining tower according to another embodiment of the present disclosure; and

FIG. 10 is an elevated cross-sectional view of a glass fining tower that may be used in various embodiments of the glass-producing system described in the present disclosure.

### DETAILED DESCRIPTION

A glass-producing system and a method of producing glass with the system are disclosed. The glass-producing system includes a glass melter that produces unfined molten glass from a vitrifiable feedstock material using submerged combustion (SC) melting technology or some other technique that generates a large amount of entrained gas bubbles in the unfined molten glass. The concentration of entrained gas bubbles in the unfined molten glass may need to be reduced significantly before the molten glass can be formed into a finished glass article. In the disclosed glass-producing system, the reduction in the concentration of entrained gas bubbles in the unfined molten glass is achieved at least in part by a one or more glass fining towers located downstream of the glass melter. Each glass fining tower includes a shell, a tubular wall, and a base receiving wall. Within the shell, the tubular wall and the base receiving wall establish an interior fining chamber, which includes an elongated vertical well, and are configured so that molten glass entering the tower experiences each of thin-layer fining, stream fining, and deep gravitational fining. Additionally, the interior fining chamber is maintained at a subatmospheric pressure and heat is introduced into a column of molten glass contained within the elongated vertical well. The combination of thin-layer fining, stream fining, and deep glass gravitational fining, while a subatmospheric pressure is maintained in the interior fining chamber and heat is introduced into the molten glass column, cooperate to remove entrained gas bubbles from molten glass flowing through the glass fining tower with good efficiency and effectiveness and, thus, contribute to more rapid fining of the unfined molten glass produced by the glass melter.

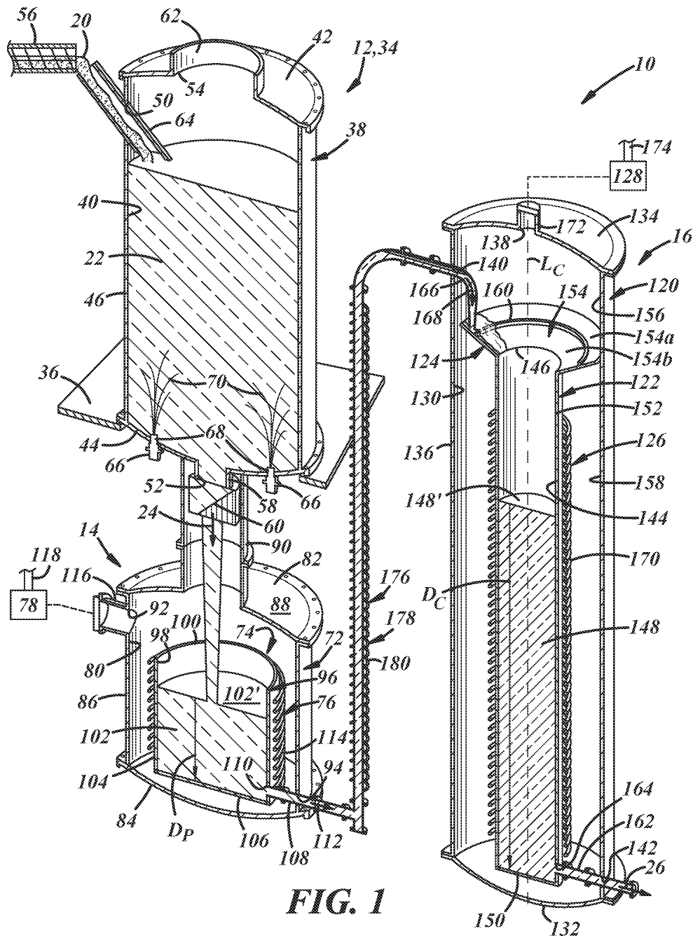

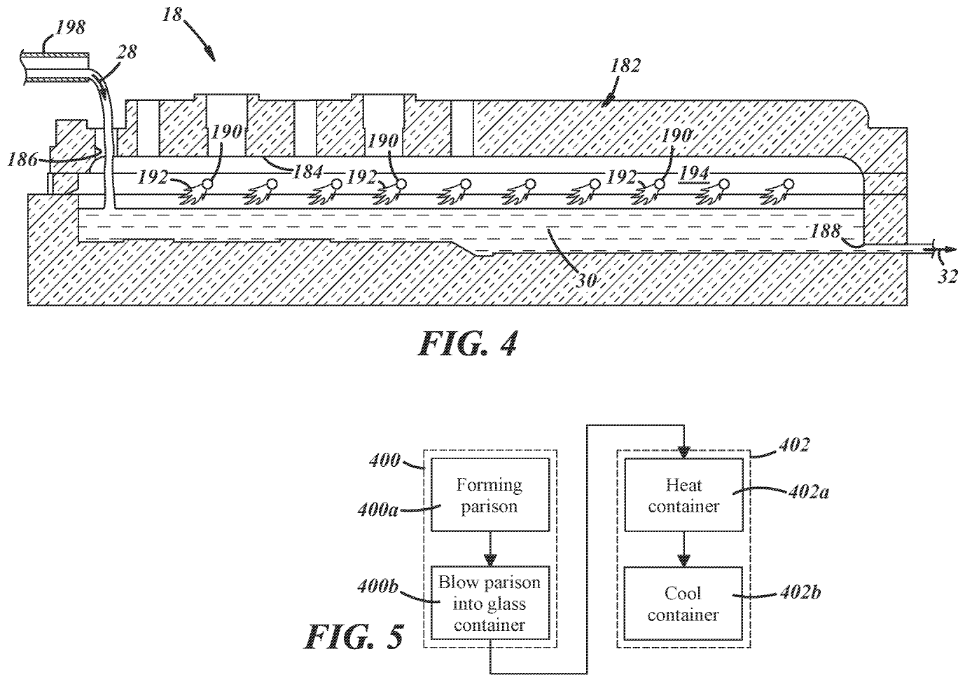

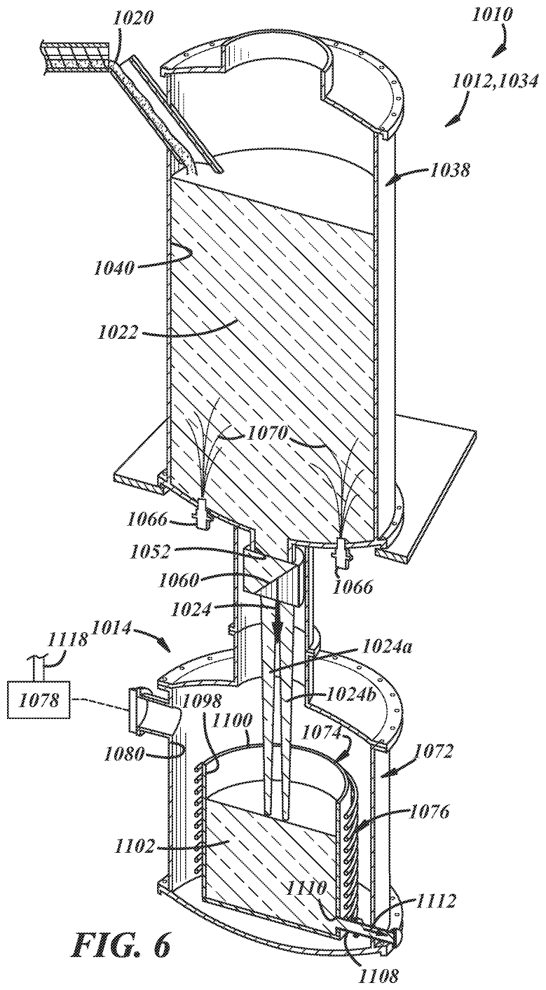

Referring now to FIGS. 1-4, a glass-producing system 10 according to one embodiment of the present disclosure is depicted. The glass-producing system 10 includes a glass melter 12, a glass prefining vessel 14 located beneath the glass melter 12, a glass fining tower 16, and a thermal conditioning tank 18 (FIG. 4). Glass flows through the glass-producing system 10 along a flow direction that begins with the glass melter 12 and moves, in successive order, to the glass prefining vessel 14 and then to the glass fining tower 16 and eventually to the thermal conditioning tank 18 where the flow direction ends. While the glass-producing system 10 may be used in conjunction with the manufacture of a variety of glass articles in various industries, it is particularly well suited for installation at a plant that manufactures glass containers such as, for example, glass bottles and glass jars. Alternate constructions and configurations of the disclosed glass-producing system are certainly possible and are described in more detail below in connection with FIGS. 6-10.

In this embodiment of the glass-producing system 10, a vitrifiable feedstock material 20 is fed to the glass melter 12 and introduced into a glass melt 22 that is comprised of unfined molten glass and contained within the glass melter 12. The vitrifiable feedstock material 20 melts within the glass melt 22 to produce more unfined molten glass while an output of unfined molten glass 24, which comprises at least 20 vol % of entrained gas bubbles, is drawn from the glass melt 22 contained in the glass melter 12. The output of unfined molten glass 24 is fined within the glass prefining vessel 14 and the glass fining tower 16 such that an outflow of molten glass 26 discharged from the glass fining tower 16 is comprised of fined molten glass. The outflow of molten glass 26 discharged from the glass fining tower 16 may serve as an input of fined molten glass 28 to the thermal conditioning tank 18. The thermal conditioning tank 18 conditions a bath of fined molten glass 30—that is, the molten glass bath 30 is thermally homogenized and brought to a forming viscosity—and supplies an output of conditioned molten glass 32. The output of conditioned molten glass 32 is then formed into glass articles such as, for example, a hollow container (e.g., a bottle or jar) by glass-forming equipment.

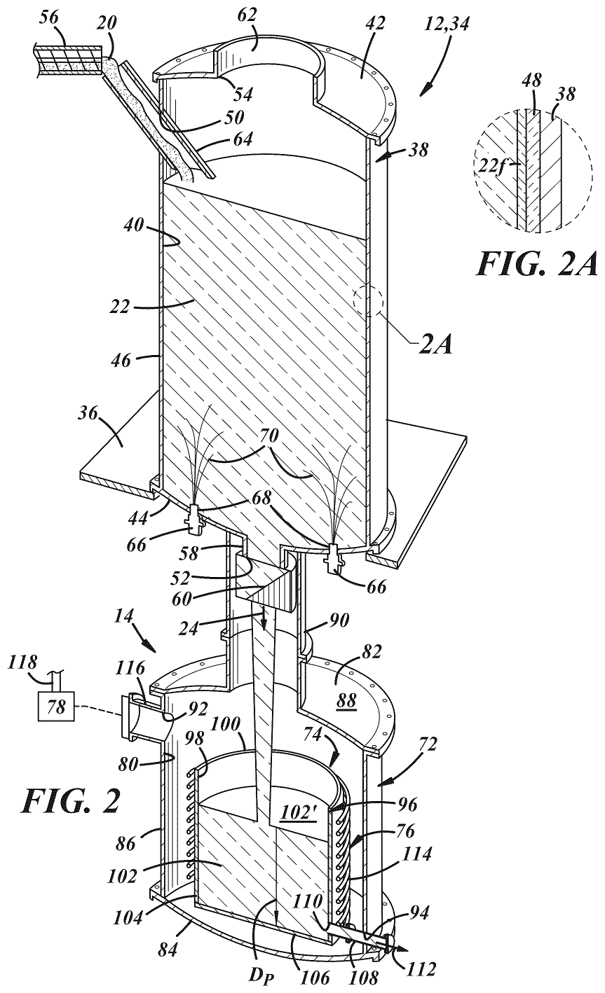

The glass melter 12, as shown, is preferably a submerged combustion (SC) melter 34 that receives and melts the vitrifiable feedstock material 20 and discharges the output of unfined molten glass 24. The SC melter 34 may be supported on a raised platform 36 or other support structure. Referring now to FIGS. 1-2, the SC melter 34 includes a housing 38 that defines a reaction chamber 40. The reaction chamber 40 holds and contains the glass melt 22, which is in a state of agitation or turbulence and provides a requisite residence time for the vitrifiable feedstock material 20 to melt-react into the unfined molten glass. The housing 38 has a roof 42, a floor 44, and a surrounding upstanding wall 46 that connects the roof 42 and the floor 44. At least the floor 44 and the upstanding side wall 46 of the housing 38, as well as the roof 42 if desired, may be constructed from one or more fluid cooled panels. Each of the fluid cooled panels defines an internal cooling space through which a coolant, such as water, may be circulated to cool the housing 38. As a result of being fluid cooled, a glass-side refractory material layer 48 covering an inside surface of the housing 38 may be covered by a layer of frozen glass 22f that forms in-situ between of the glass melt 22 and the refractory material layer 48, as shown in FIG. 2A. The glass-side refractory material layer 48 may be composed of AZS (i.e., fuse case, bond, or castable alumina-zirconia-silica) or some other refractory. In other embodiments, the housing 38 may be formed of dual metal, fluid-cooled walls that lack a glass-side refractory material layer.

The housing 38 of the SC melter 34 defines a feed material inlet 50, a molten glass outlet 52, and an exhaust vent 54 of the melter 34. The feed material inlet 50 may be defined in the surrounding upstanding wall 46 of the housing 38 below the roof 42 yet above the glass melt 22, and the molten glass outlet 52 may be defined in the floor 44 of the housing 34, although other locations for the feed material inlet 50 and the molten glass outlet 52 are certainly possible, including locating the feed material inlet 50 for submerged feeding into the glass melt 22. The feed material inlet 50 provides an entrance to the reaction chamber 40 for the delivery of the vitrifiable feedstock material 20. A batch feeder 56 that is configured to introduce a metered amount of the vitrifiable feedstock material 20 into the reaction chamber 40 may be coupled or located proximate to the housing 38. The batch feeder 56 may, for example, include a rotating screw that rotates within a feed tube to deliver the vitrifiable feedstock material 20 into the reaction chamber 40 at a controlled rate. The molten glass outlet 52 provides an exit from the reaction chamber 40 for the discharge of the output of unfined molten glass 24 out of the SC melter 34. The molten glass outlet 52 may be downwardly displaced from a surrounding portion of the floor 44 by an exit conduit 58 provided in the floor 44 of the housing 38. A flow controller 60 may, if desired, by coupled to the molten glass outlet 52 so that the flow rate of the output of unfined molten glass 24 can be controlled. The flow controller 60 may be any variable restriction flow control device including, for example, a flow control valve or a shutter.

The exhaust vent 54 is preferably defined in the roof 42 of the housing 38. An exhaust duct 62 communicates with the exhaust vent 54 and is configured to remove gaseous compounds from the reaction chamber 40. The gaseous compounds removed through the exhaust duct 62 may be treated, recycled, or otherwise managed away from the SC melter 34 as needed. To help prevent or at least minimize the potential loss of some of the vitrifiable feedstock material 20 through the exhaust vent 54 as unintentional feedstock material carryover, an enclosed feeding conduit 64 may extend from the feed material inlet 50 into the reaction chamber 40 to help deliver the vitrifiable feedstock material 20 into the glass melt 22. The enclosed feeding conduit 64 may terminate just above the glass melt 22, as shown, or it may extend into the glass melt 22. Preferably, the enclosed feeding conduit 64 is constructed from a fluid-cooled tube similar in function to the panels that may be used to construct at least a portion of the housing 38.

The SC melter 34 includes one or more submerged burners 66. Each of the one or more submerged burners 66 is mounted to the floor 42 (as shown) and/or to the surrounding upstanding wall 46 at a portion of the wall 46 that is immersed by the glass melt 22. Each of the submerged burner(s) 66 forcibly injects a combustible gas mixture into the glass melt 22 through an output nozzle 68. The combustible gas mixture comprises a fuel and an oxidant. The fuel supplied to the submerged burner(s) 66 is preferably methane or propane, and the oxidant is preferably pure oxygen (≥99 vol % O₂) or an oxygen-enriched gas that includes a high percentage (≥80 vol %) of oxygen, in which case the burner(s) 66 are oxy-fuel burners, or it may be air. Upon being injected into the glass melt 22, the combustible gas mixture immediately autoignites to produce combustion products 70—namely, CO₂, CO, H₂O, and any uncombusted fuel, oxygen, and/or other gas compounds such as nitrogen in the event the fuel is a hydrocarbon—that are discharged into and through the glass melt 22. Anywhere from five to thirty submerged burners 66 may be installed in the SC melter 34 although more or less may certainly be used depending on the size and melt capacity of the melter 34.

The vitrifiable feedstock material 20 that is fed to the SC melter 34 may be formulated to produce, upon melt-reaction within the agitated glass melt 22, any type of glass with a specified glass chemistry. Soda-lime-silica glass, for example, is used extensively to manufacture flat glass articles including windows, hollow glass articles including containers such as bottles and jars, and also tableware and other specialty articles. Soda-lime-silica glass, in general and based on the total weight of the glass, has a glass chemical composition that includes 60 wt % to 80 wt % SiO₂, 8 wt % to 18 wt % Na₂O, and 5 wt % to 15 wt % CaO. In addition to SiO₂, Na₂O, and CaO, the glass chemical composition of soda-lime-silica glass may include network formers, intermediate formers, network modifiers, colorants, decolorants, redox agents, or other agents that affect the properties of the final glass. Some examples of these additional materials include aluminum oxide (Al₂O₃), magnesium oxide (MgO), potassium oxide (K₂O), carbon, sulfates, nitrates, fluorines, chlorines, and/or elemental or oxide forms of one or more of iron, arsenic, antimony, selenium, chromium, barium, manganese, cobalt, nickel, sulfur, vanadium, titanium, lead, copper, niobium, molybdenum, lithium, silver, strontium, cadmium, indium, tin, gold, cerium, praseodymium, neodymium, europium, gadolinium, erbium, and uranium. Aluminum oxide is one of the more commonly included materials-typically present in an amount up to 2 wt % based on the total weight of the glass-because of its ability to improve the chemical durability of the glass and to reduce the likelihood of devitrification.

To produce soda-lime-silica glass, the vitrifiable feedstock material 20 may be a physical mixture of virgin raw materials and optionally cullet and/or other glass precursor oxides that provides a source of SiO₂, Na₂O, and CaO in the correct proportions along with any of the other components of the glass listed below in Table 1 including, most commonly, Al₂O₃. For example, the vitrifiable feedstock material 20 may include raw materials such as quartz sand (crystalline SiO₂), soda ash (Na₂CO₃), and limestone (CaCO₃) in the quantities needed to provide the requisite proportions of SiO₂, Na₂O, and CaO, respectively. Other raw materials may also be included in the vitrifiable feedstock material 20 to contribute one or more of SiO₂, Na₂O, CaO, and possibly other oxide and/or non-oxide materials depending on the desired chemistry and color of the soda-lime-silica glass being formed. These other virgin raw materials may include feldspar, dolomite, and calumite slag. The vitrifiable feedstock material 20 may include up to 80 wt % cullet, depending on a variety of factors, and may additionally include secondary materials that provide the soda-lime-silica glass with colorants, decolorants, and/or redox agents, and in some instances may include chemical fining agents. Of course, the exact formulation of the vitrifiable feedstock material 20 is subject to variation while still being able to produce soda-lime-silica glass with the correct chemical composition as is generally well known in the glass manufacturing industry.

TABLE 1
Glass Chemical Composition of Soda-Lime-Silica Glass

| Component | Weight % | Raw Material Sources |
|---|---|---|
| SiO₂ | 60-80 | Quartz sand |
| Na₂O | 8-18 | Soda ash |
| CaO | 5-15 | Limestone |
| Al₂O₃ | 0-2 | Nepheline Syenite, Feldspar |
| MgO | 0-5 | Magnesite |
| K₂O | 0-3 | Potash |
| Fe₂O₃ + FeO | 0-0.08 | Iron is a contaminant |
| MnO₂ | 0-0.3 | Manganese Dioxide |
| SO₃ | 0-0.5 | Salt Cake, Slag |
| Se | 0-0.0005 | Selenium |

The glass prefining vessel 14 is located beneath the SC melter 34 and receives the output of unfined molten glass 24 from the SC melter 34. The glass prefining vessel 14 includes a shell 72, a vat 74 enclosed by the shell 72, a heater 76, and a vacuum source 78. The shell 72 defines an internal fining chamber 80 and includes a roof 82, a floor 84, and a sidewall 86 that connects the roof 82 and the floor 84. The roof 82 includes a base 88 and a stack 90 that extends upwards from the base 88. The stack 90 of the roof 82 of the glass fining vessel 14 connects with the floor 44 of the housing 38 of the SC melter 34. The stack 90 surrounds the molten glass outlet 52 of the SC melter 34, which results in the molten glass outlet 52 and the flow controller 60, if present, being contained within the internal fining chamber 80 of the glass prefining vessel 14. The stack 90 and the floor 44 of the housing 38 of the SC melter 34 are hermetically sealed and any type of connection between the two components 44, 90 that enables such sealing may be employed including a construction in which a portion of the stack 90 is integrally formed with the floor 44 of the housing 38 of the SC melter 34 and a portion is integrally formed with the roof 82 of the shell 72 and, in turn, the two portions are coupled together. Additionally, a vacuum port 92 and an exit opening 94 are defined in the shell 72. The vacuum port 92 is preferably defined in the sidewall 86, as shown, or the roof 82, and the exit opening 94 is preferably defined in the sidewall 86 proximate the floor 84 of the shell 72 (i.e., closer to the floor 84 than the roof 82).

The vat 74 includes a drum wall 96 that defines a glass-holding zone 98 within the internal fining chamber 80 of the glass prefining vessel 14 beneath the molten glass outlet 52 of the SC melter 34. The drum wall 96 provides an unobstructed opening 100 to the glass-holding zone 98 that is spanned by an entrance plane. To that end, the open glass-holding zone 98 established by the drum wall 96 is a delineated volume of the internal fining chamber 80. A pool of molten glass 102 having a depth D_{P} measured downwardly from a top surface 102′ of the molten glass pool 102 is contained within the glass-holding zone 98. The molten glass pool 102 is supplied by the output of unfined molten glass 24, which, upon being discharged from the SC melter 34, falls through the stack 90 and into the glass-holding zone 98 of the vat 74 through the opening 100. The drum wall 96, as shown, includes a sidewall 104 that extends upwardly from a floor 106, which is disposed on or above the floor 84 of the shell 72 of the glass fining vessel 14 and is also part of the drum wall 96, to establish the glass-holding zone 98. In an alternate implementation, the sidewall 104 of the drum wall 96 may extend directly upwardly from the floor 84 of the shell 72 to establish the glass-holding zone 98. The drum wall 96 has a height, which is the distance the drum wall 96 extends upwardly in a direction away from the floor 84 of the shell 72, that is greater than the depth D_{P} of the molten glass pool 102. The drum wall 96 may be constructed from a fluid or non-fluid cooled material and may also include a susceptor material to facilitate inductive heating.

An exit conduit 108 that fluidly communicates with an outlet 110 defined in the drum wall 96 and, in particular, the sidewall 104, is coupled to the drum wall 96. The outlet 110 is immersed by the molten glass pool 102 and preferably communicates with a bottomhalf of the molten glass pool 102 (i.e., the portion of the pool 102 beyond 50% of the depth D_{P} of the pool 102) or, more preferably, the bottomquarter of the molten glass pool 102 (i.e., the portion of the pool 102 beyond 75% of the depth D_{P} of the pool 102) or even the bottomtenth of the molten glass pool 102 (i.e., the portion of the pool 102 beyond 90% of the depth D_{P} of the pool 102). The exit conduit 108 extends transversely and outwardly from the drum wall 96 and through the exit opening 94 of the shell 72. The exit conduit 108 thus communicates with the glass-holding zone 98 via the outlet 110 and is the flow passage by which molten glass is drawn from the molten glass pool 102 and discharged from the glass prefining vessel 14 as an outflow of molten glass 112 that ultimately feeds the glass fining tower 16. The shell 72 and the exit conduit 108 are hermetically sealed by any type of connection at the exit opening 94. The hermetic seal between the exit conduit 108 and the shell 72, as well as the hermetic seal that seals the stack 90, allow the for a subatmospheric pressure to be maintained in the internal fining chamber 80 of the glass fining vessel 14.

The heater 76 is operable to introduce heat into the molten glass pool 102 through the drum wall 96. The heater 76 may be an induction heater, as shown, that includes one or more induction heating coils 114 disposed around the sidewall 104 of the drum wall 96, which may be constructed from a susceptor material suitable for induction heating. The induction heating coil(s) 114 may extend heightwise along the sidewall 104 and cover at least the portion of the sidewall 104 that contacts the molten glass pool 102, or, in an alternate implementation, the coil(s) 114 may extend heightwise along the sidewall 104 and cover the entire sidewall 104. The induction heating coil(s) 114 may be embedded, either fully or partially, in the sidewall 104 of the drum wall 96 or the coil(s) 114 may be disposed around and optionally in contact with the outside of the sidewall 104. Each of the induction heating coils 114 may be an electromagnetic coil, which is typically composed of copper. A controllable RF power supply or other suitable power source is electrically connected to the induction heating coil(s) 114 and is configured to deliver a high-frequency AC current through the coil(s) 114 to create an alternating magnetic field capable of heating the sidewall 104 and introducing heat into the molten glass pool 102. As another option, and instead of an induction heater, the heater 76 may be an electric heater, a microwave heater, or a combustion heater. The heater 76, in operation, can be controlled to maintain the molten glass pool 102 at a temperature that ranges anywhere from 1250° C. to 1700° C.

The vacuum source 78 is preferably a vacuum pump such as a positive displacement pump or a momentum transfer pump. The vacuum source 78 is fluidly connected to the vacuum port 92 defined in the shell 72 by way of a vacuum conduit 116. In this way, the vacuum source 78 is operable to reduce a pressure of the internal fining chamber 80 to a subatmospheric level. For instance, the vacuum source 78 may be operated to bring and maintain the pressure, measured as absolute pressure, within the internal fining chamber 80 to anywhere between 5 torr and 750 torr. The vacuum conduit 116 may also fluidly communicate with an exhaust conduit 118 so that any gaseous compounds removed from the internal fining chamber 80 can be directed away from the glass fining vessel 14 for appropriate downstream management.

The glass fining tower 16 is located downstream of the glass prefining vessel 14 in the flow direction of glass through the glass-producing system 10. The glass fining tower 16 includes a shell 120, a tubular wall 122, a base receiving wall 124, a heater 126, and a vacuum source 128. The shell 120 defines an inner space 130 and includes a base 132, a cap 134, and an elongated sidewall 136 that extends between and connects the base 132 and the cap 134. The shell 120 is vertically elongated in that a height H_{TOW} of the shell 120 is greater than a width W_{TOW} of the shell 120 while being sufficiently sized in the height and width dimensions to accommodate the tubular wall 122, the base receiving wall 124, and the heater 126. The height H_{TOW} of the shell 120 is the distance between the base 132 and the cap 134 along a longitudinal centerline L_{C} of the shell 120, which may be aligned with a gravity vector V_{G} or at an angle of up to 45° from the gravity vector V_{G}, and the width W_{TOW} of the shell 120 is the distance between opposed portions of the elongated sidewall 136 perpendicular to the longitudinal centerline L_{C}. Additionally, a vacuum port 138, an inlet opening 140, and an exit opening 142 are defined in the shell 120. The vacuum port 138 is preferably defined in the cap 134, as shown, or the elongated sidewall 136, and the inlet opening 140 and the exit opening 142 are preferably defined in the elongated sidewall 136 proximate the cap 134 and proximate the base 132, respectively.

The tubular wall 122 is disposed within, and is surrounded by, the shell 120. The tubular wall 122 extends longitudinally along the longitudinal centerline L_{C} of the shell 120 and defines an elongated vertical well 144 having an opening 146. A column of molten glass 148 having a depth D_{C} as measured downwardly from a top surface 148′ of the molten glass column 148 is contained within the elongated vertical well 144. As shown, the tubular wall 122 includes a transverse base wall 150, which is disposed on or above the base 132 of the shell 120, and a peripheral sidewall 152 that extends upwardly from the transverse base wall 150 to provide the elongated vertical well 144. In an alternate implementation, the peripheral sidewall 152 of the tubular wall 122 may extend directly upwardly from the base 132 of the shell 120 to provide the elongated vertical well 144. The tubular wall 122 has a height H_{WELL} and a width W_{WELL}. The height H_{WELL} of the tubular wall 122 is the distance the tubular wall 122 extends along the longitudinal centerline L_{C} of the shell 120 and the width W_{WELL}, of the tubular wall 122 is the distance between opposed portions of the tubular wall 122 perpendicular to the longitudinal centerline L_{C} of the shell 120. The height H_{WELL}, of the tubular wall 122 is greater than the width W_{WELL} of the tubular wall 122, preferably by a factor of at least 2. Indeed, in one implementation, a ratio of the height H_{WELL}, to the width W_{WELL}, of the tubular wall 122 preferably ranges from 30:1 to 2:1 or, more narrowly, from 15:1 to 5:1. The depth De of the molten glass column 148 covers at least 20% and, more preferably, between 25% and 65%, of the height H_{WELL}, of the tubular wall 122. The tubular wall 122 may constructed from a fluid or non-fluid cooled material and may also include a susceptor material to facilitate inductive heating.

The base receiving wall 124 is also disposed within the shell 120. The base receiving wall 124 extends inwardly from the shell 120 and, in particular, the elongated sidewall 136, to the tubular wall 122 to provide a glass distribution surface 154 that at least partially surrounds the opening 146 of the elongated vertical well 144. The base receiving wall 124 and the tubular wall 122 divide the inner space 130 of the shell 120 into an interior fining chamber 156, which comprises the space above the base receiving wall 124 and the elongated vertical well 144, and a perimeter space 158 that surrounds the tubular wall 122 below the base receiving wall 124. The glass distribution surface 154 tapers downwardly to the opening 146 of the elongated vertical well 144 and, in this embodiment, additionally defines a protruding lip 160 that surrounds the opening 146 of the elongated vertical well 144 and separates the glass distribution surface 154 into an outer portion 154a of the surface 154 that lies adjacent to the shell 120 and an inner portion 154b of the surface 154 that lies adjacent to the opening 146. As will be discussed in more detail below, the protruding lip 160 allows for molten glass to accumulate and spread over the outer portion 154a of the glass distribution surface 154 before spilling over the protruding lip 160 as a layer of glass that flows evenly over the inner portion 154b of the glass distribution surface 154. This flowing glass layer then pours into the elongated vertical well 144 around the opening 146 of the well 144 over the entire inner portion 154b of the glass distribution surface 154. In this way, the glass distribution surface 154 of the base receiving wall 124 provokes both thin-layer fining and stream fining of glass within the interior fining chamber 156, which together account for a sizeable proportion of the fining that occurs in the glass fining tower 16.

An exit conduit 162 that fluidly communicates with an outlet 164 defined in the tubular wall 122 and, in particular, the peripheral sidewall 152, is coupled to the tubular wall 122. The outlet 164 is immersed by the molten glass column 148 and preferably communicates with a bottomhalf of the molten glass column 148 (i.e., the portion of the column 148 beyond 50% of the depth D_{C} of the column 148) or, more preferably, with a bottomquarter of the molten glass column 148 (i.e., the portion of the column 148 beyond 75% of the depth D_{C} of the column 148) or even a bottomtenth of the molten glass column 148 (i.e., the portion of the column 148 beyond 90% of the depth D_{C} of the column 148). The exit conduit 162 extends transversely and outwardly from the tubular wall 122 and through the exit opening 142 of the shell 120. The exit conduit 162 thus communicates with the elongated vertical well 144 via the outlet 164 and is the flow passage by which molten glass is drawn from the molten glass column 148 and discharged from the glass fining tower 16 as the outflow of molten glass 26 that ultimately feeds the thermal conditioning tank 18. Additionally, an inlet conduit 166 that fluidly communicates with the inlet opening 140 may be coupled to the shell 120 and, in particular, the elongated sidewall 136, to introduce an inflow of molten glass 168 into the interior fining chamber 156. The inlet opening 140 is preferably defined in the elongated sidewall 136 above the base receiving wall 124. The inlet conduit 166 extends into the interior fining chamber 156 from the inlet opening 140 and terminates above the outer portion 154a of the glass distribution surface 154. The shell 120 and each of the exit conduit 162 and the inlet conduit 166 are hermetically sealed by any type of connection at the exit opening 142 and the inlet opening 140, respectively. The hermetic seals allow the for a subatmospheric pressure to be maintained in the interior fining chamber 156 of the glass fining tower 16.

The heater 126 is operable to introduce heat into the molten glass column 148 through the tubular wall 122. The heater 126 may be an induction heater, as shown, that includes one or more induction heating coils 170 disposed around the peripheral sidewall 152 of the tubular wall 122, which may be constructed from a susceptor material suitable for induction heating, within the perimeter space 158 of the glass fining tower 16. The induction heating coil(s) 170 may extend heightwise along the peripheral sidewall 152 and cover at least the portion of the peripheral sidewall 152 that contacts the molten glass column 148, or, in an alternate implementation, the coil(s) 170 may extend heightwise along the peripheral sidewall 152 and cover the entire peripheral sidewall 152. The induction heating coil(s) 170 may be embedded, either fully or partially, in the peripheral sidewall 152 of the tubular wall 122 or the coil(s) 170 may be disposed around and optionally in contact with the outside of the peripheral sidewall 152. Each of the induction heating coils 170 may be an electromagnetic coil, which is typically composed of copper. And, in the same manner as before, a controllable RF power supply or other suitable power source is electrically connected to the induction heating coil(s) 170 and is configured to deliver a high-frequency AC current through the coil(s) 170 to create an alternating magnetic field capable of heating the peripheral sidewall 152 and, ultimately, introducing heat into the molten glass column 148. As another option, and instead of an induction heater, the heater 126 may be an electric heater, a microwave heater, or a combustion heater. The heater 126, in operation, can be controlled to maintain the molten glass column 148 at a temperature that ranges anywhere from 1250° C. to 1700° C.

The vacuum source 128 is preferably a vacuum pump such as a positive displacement pump or a momentum transfer pump. The vacuum source 128 is fluidly connected to the vacuum port 138 defined in the shell 120 by way of a vacuum conduit 172. In this way, the vacuum source 128 is operable to reduce a pressure of the interior fining chamber 156 to a subatmospheric level. For instance, the vacuum source 128 may be operated to bring and maintain the pressure, measured as absolute pressure, within the interior fining chamber 156 to anywhere between 5 torr and 750 torr. The pressure of the interior fining chamber 156 of the glass fining tower 16 is at least equal to, and preferably less than, the pressure of the internal fining chamber 80 of the glass prefining vessel 14. The vacuum conduit 172 may also fluidly communicate with an exhaust conduit 174 so that any gaseous compounds removed from the interior fining chamber 156 can be directed away from the glass fining tower 16 for appropriate downstream management.

The glass prefining vessel 14 and the glass fining tower 16 are fluidly connected by a glass transfer conduit 176 that transfers molten glass between the two fining units 14, 16. The glass transfer conduit 176 is connected at one end to the exit conduit 108 that communicates with the outlet 110 defined in the drum wall 96 of the vat 74, and is connected at the other end to the inlet conduit 166 that communicates with the inlet opening 140 of the shell 120. To that end, the outflow of molten glass 112 that is drawn from the molten glass pool 102 and discharged from the glass prefining vessel 14 is conveyed to the glass fining tower 16 by the glass transfer conduit 176 and serves as the inflow of molten glass 168 that is received in the interior fining chamber 156 of the glass fining tower 16. The outflow of molten glass 112 may be transferred to the inlet opening 140 of the shell 120 of the glass fining tower 16 in any of a variety of ways. For instance, the subatmospheric pressure maintained in the interior fining chamber 156 of the glass fining tower 16 may be low enough, compared to the subatmospheric pressure maintained in the internal fining chamber 80 of the glass prefining vessel 14, that the difference in pressures between the two chambers 80, 156 and the head pressure provided by the molten glass pool 102 are sufficient to move the molten glass through the glass transfer conduit 176. In another implementation, a pump may be provided to help move the molten glass through the glass transfer conduit 176.

To help ensure that the molten glass traveling through the glass transfer conduit 176 does not lose too much heat when being transferred between the glass prefining vessel 14 and the glass fining tower 16, a heater 178 may be thermally interconnected to the glass transfer conduit 176. The heater 178 may be an induction heater, as shown, that includes one or more induction heating coils 180 disposed around the glass transfer conduit 176, which may be constructed from a susceptor material suitable for induction heating. Each of the induction heating coils 180 may be an electromagnetic coil, which is typically composed of copper. And, in the same manner as before, a controllable RF power supply or other suitable power source is electrically connected to the induction heating coil(s) 180 and is configured to deliver a high-frequency AC current through the coil(s) 180 to create an alternating magnetic field capable of heating the glass transfer conduit 176 and, ultimately, introducing heat into the molten glass traveling through the glass transfer conduit 176. As another option, and instead of an induction heater, the heater 178 may be an electric heater, a microwave heater, or a combustion heater. The heater 178, in operation, can be controlled to maintain the molten glass within the glass transfer conduit 176 at a temperature that ranges anywhere from 1250° C. to 1700° C.

In this embodiment, the outflow of molten glass 26 that is discharged from the glass fining tower 16 is comprised of fined molten glass and, as such, does not need to undergo any further fining before entering the thermal conditioning tank 18. While exactly what constitutes fined molten glass depends on a variety of factors including the particular chemistry of the glass and the intended end-use of the glass, a standard for fined glass that applies to soda-lime-silica glass produced for hollow containers may demand a bubble count of (i) zero blisters (i.e., gas bubbles having a diameter of 0.8 mm or greater) and (ii) less than 0.5 seeds (i.e., gas bubbles having a diameter of less than 0.8 mm) per gram of glass. When this is the case, a glass density of the glass may range from 2.3 gm/cm³ to 2.5 gm/cm³, compared to a glass density of 0.75 gm/cm³ to 1.5 gm/cm³ for the glass contained in the output of unfined molten glass 24 that is discharged from the SC melter 34. Because the outflow of molten glass 26 discharged from the glass fining tower 16 is comprised of fined molten glass, the outflow of molten glass 26 may be delivered to the thermal conditioning tank 18 as the input of fined molten glass 28.

The thermal conditioning tank 18 is positioned downstream of the glass fining tower 16 relative to the flow direction of glass through the glass-producing system 10. The thermal conditioning tank 18 includes a housing 182 that defines a conditioning chamber 184. The housing 182 of the thermal conditioning tank 18 is an elongated structure—such as a forehearth—and has defined therein an inlet 186 and an outlet 188. The housing 182 is formed at least in part from a refractory material that can withstand the elevated temperatures typically associated with the molten glass bath 30. The input of fined molten glass 28, which is provided by the outflow of molten glass 26 discharged from the glass fining tower 16, is received into the conditioning chamber 184 through the inlet 186 and is introduced into the molten glass bath 30 that is held within the conditioning chamber 184. The molten glass bath 30 flows from the inlet 186 to the outlet 188 of the thermal conditioning tank 18.

A plurality of non-submerged burners 190 are mounted in the housing 182 of the thermal conditioning tank 18 to provide a source of radiant heat. These burners 190 are fed with a gas mixture of a fuel and an oxidant and discharge a flame 192 into an open combustion zone 194 within the conditioning chamber 184 above the flowing molten glass bath 30. The non-submerged burners 190 are operated in combination with cooling air to condition the molten glass; that is, to control the temperature of the flowing molten glass bath 30 along a direction extending from the inlet 186 to the outlet 188 and to homogenize the temperature of the glass to bring the glass to a glass viscosity appropriate for downstream glass forming operations. For glass-container forming operations, the flowing molten glass bath 30 is typically brought to a glass viscosity at the outlet 188 of the thermal conditioning tank 18 that ranges from 10³ Pa·s to 10² Pa·s, which coincides with a glass temperature that typically ranges from 1050° C. to 1200° C., for soda-lime-silica glass. At the outlet 188 of the thermal conditioning tank 18, the output of conditioned molten glass 32 is drawn from the flowing molten glass bath 30 and removed or pulled from the conditioning chamber 184.

The glass-producing system 10 described above can produce glass while occupying a compact industrial footprint. Referring now more specifically to FIGS. 1-5, a method of producing glass is described in the context of melting, fining, and conditioning soda-lime-silica glass, although it should be appreciated that the same methodology may be applied to other glass chemistries as well. During operation of the glass melter 12, which, here, is the SC melter 34, each of the one or more submerged burners 66 individually discharges combustion products 70 directly into and through the glass melt 22. The glass melt 22 is a volume of unfined molten glass that often weighs between 1 US ton (1 US ton=2,000 lbs) and 150 US tons and is generally maintained at a constant volume during steady-state operation of the SC melter 34. As the combustion products 70 are thrust into and through the glass melt 22, which in turn creates complex flow patterns and severe turbulence, the glass melt 22 is vigorously agitated and experiences rapid heat transfer and intense shearing forces. The combustion products 70 eventually escape the glass melt 22 and are removed from the reaction chamber 40 through the exhaust vent 54 along with any other gaseous compounds that may volatize out of the glass melt 22.

While the one or more submerged burners 66 are firing their combustion products 70 directly into the glass melt 22, the vitrifiable feedstock material 20 is controllably introduced into the reaction chamber 40 through the feed material inlet 50. The vitrifiable feedstock material 20 does not form a batch blanket that rests on top of the glass melt 22 as is the case with a conventional continuous melting furnace; rather, the vitrifiable feedstock material 20 is rapidly disbanded and consumed by the agitated glass melt 22. The dispersed vitrifiable feedstock material 20 is subjected to intense heat transfer and rapid particle dissolution throughout the glass melt 22 due to the vigorous melt agitation and shearing forces induced by the submerged burner(s) 66. This causes the vitrifiable feedstock material 20 to quickly mix, react, and melt into the glass melt 22. However, the agitation and stirring of the glass melt 22 caused by the discharged combustion products 70 also creates bubbles within the glass melt 22. Consequently, the glass melt 22 is foamy in nature and includes a homogeneous distribution of entrained gas bubbles. The entrained gas bubbles may account for 20 vol % to 60 vol % of the glass melt 22, or more narrowly from 30 vol % to 50 vol %, which renders the density of the glass melt 22 relatively low, typically ranging from 0.75 gm/cm³ to 1.5 gm/cm³, or more narrowly from 0.99 gm/cm³ to 1.3 gm/cm³, for soda-lime-silica glass. The gas bubbles entrained within the glass melt 22 vary in size and may contain any of several gases including CO₂, H₂O (vapor), N₂, SO₂, CH₄, CO, uncombusted fuel, and volatile organic compounds (VOCs).

The output of unfined molten glass 24 that is discharged from the SC melter 34 through the molten glass outlet 52 is drawn from the glass melt 22. The output of unfined molten glass 24 is chemically homogenized to the desired glass chemical composition, e.g., a soda-lime-silica glass chemical composition, and has the same relatively low density and concentration of entrained gas bubbles as the glass melt 22. The output of unfined molten glass 24 falls through the internal fining chamber 80 and combines with the molten glass pool 102 contained within the glass-holding zone 98 defined by the drum wall 96 of the vat 74. The flow of the output of unfined molten glass 24 out of the SC melter 34 may be controlled by the flow controller 60, if present, or it may be controlled by other process parameters such as the pressure in the internal fining chamber 80 of the glass prefining vessel 14, the depth of the glass melt 22 in the SC melter 34, and/or the temperature of the glass in the glass melt 22. In the glass prefining vessel 14, the pressure of the internal fining chamber 80 may be maintained between 5 torr and 750 torr or, more narrowly, between 100 torr and 400 torr, and the temperature of the molten glass pool 102 may be maintained at a temperature ranging from 1250° C. to 1700° C. or, more narrowly, from 1250° C. to 1650° C. or even from 1350C° to 1550° C.

The glass prefining vessel 14 partially fines the output of unfined molten glass 24 within the molten glass pool 102 to reduce the fining demands on the downstream glass fining tower 16. The partial vacuum maintained in the internal fining chamber 80 and the heating supplied by the heater 76 cooperate to promote the ascension of gas bubbles upwards through the molten glass pool 102 towards the top surface 102′ of the molten glass pool 102 where the bubbles eventually escape and burst. The outflow of molten glass 112 that is discharged from the glass prefining vessel 14 through the outlet 110 defined in the drum wall 96 and then through the exit conduit 108, which is preferably drawn from the bottomhalf of the molten glass pool 102, thus has a lower concentration of entrained gas bubbles than that of the output of unfined molten glass 24 discharged from the SC melter 34. After exiting the glass prefining vessel 14, the outflow of molten glass 112 enters the glass transfer conduit 176. The outflow of molten glass is 112 transported through the glass transfer conduit 176 and becomes the inflow of molten glass 168 that is introduced into the interior fining chamber 156 of the glass fining tower 16 through the inlet opening 140 of the shell 120 and the inlet conduit 166. The heater 176 introduces heat into the molten glass that flows through the glass transfer conduit 176. This keeps the molten glass from losing too much heat, which may be helpful to the overall fining process since an increase in glass viscosity (resulting from a decrease in glass temperature) generally slows the rate of gas bubble removal from the glass.

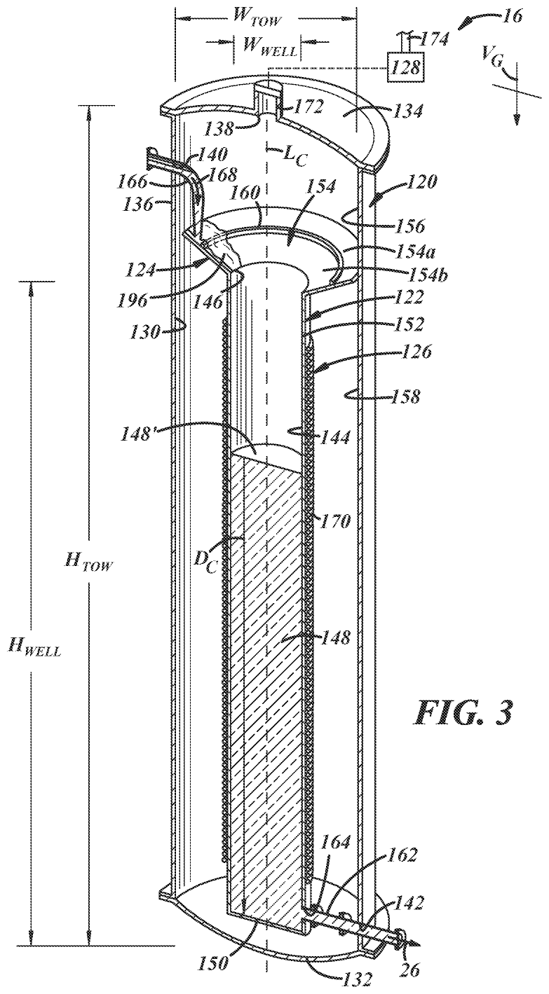

The inflow of molten glass 168 that is introduced into the interior fining chamber 156 of the glass fining tower 16 is delivered onto the base receiving wall 124 and flows over the base receiving wall 124 into the elongated vertical well 144. In particular, in this embodiment, the inflow of molten glass 168 is poured onto the outer portion 154a of the glass distribution surface 154 where is spreads out behind the protruding lip 160 and around the opening 146 of the elongated vertical well 144 to form an overspilling glass layer 196 (FIG. 3) that at least partially surrounds the opening 146. By spreading out the inflow of molten glass 168 as the overspilling glass layer 196, thin-layer fining is invoked and the release of entrained glass bubbles from the molten glass into the interior fining chamber 156 of the glass fining tower 16 is easier due to the minimal depth of the glass layer 196 through which the gas bubbles must ascend. The overspilling glass layer 196 flows over the protruding lip 160 and inward across the inner portion 154b of the glass distribution surface 154 into the elongated vertical well 144. The overspilling glass layer 196 then falls into the elongated vertical well 144, typically adjacent to and along the peripheral sidewall 152 of the tubular wall 122, invoking stream fining during which the release of entrained gas bubbles is promoted by the change in flow direction of the overspilling glass layer 196 as the layer 196 pours into the elongated vertical well 144.

The overspilling glass layer 196 flows downwardly into the elongated vertical well 144 and feeds the molten glass column 148. The shape of the elongated vertical well 144 and the depth D_{C} of the molten glass column 148—the molten glass column 148 generally having a greater depth D_{C} and being more narrow along its depth De than glass in a conventional fining chamber or a forehearth—facilitates deep gravitational fining by allowing the molten glass within the molten glass column 148 to gravitationally separate by density. As a result of providing the molten glass column 148 within the vertically elongated well 144, entrained gas bubbles are guided upwards within the molten glass column 148 and more space exists for higher-density molten glass to sink and gravitationally separate from lower-density molten glass. An increasing density gradient exists down the depth D_{C} of the molten glass column 148. While deep gravitational fining contributes in many cases to the overall fining capability of the glass fining tower 16, the combination of thin-layer fining and stream fining usually accounts for a larger proportion of the fining that occurs in the glass fining tower 16 than deep gravitational fining.

In the glass fining tower 16, the pressure of the interior fining chamber 156 may be maintained between 5 torr and 750 torr or, more narrowly, between 100 torr and 400 torr, and the temperature of the molten glass column 148 may be maintained at a temperature ranging from 1250° C. to 1700° C. or, more narrowly, from 1250° C. to 1650° C. or even from 1350C° to 1550° C. The pressure in the interior fining chamber 156 of the glass fining tower 16 is preferably less than the pressure of the internal fining chamber 80 of the glass fining vessel 14 since fewer and smaller entrained gas bubbles are typically present in the molten glass column 148 compared to the molten glass pool 102. The pressure of the interior fining chamber 156 is reduced to a partial vacuum because the velocity at which the entrained gas bubbles rise through the overspilling layer 196 and the molten glass column 148 is enhanced by the subatmospheric pressure of the interior fining chamber 156. Additionally, the introduction of heat into the molten glass column 148 by the heater 126 to, preferably, at least maintain the temperature of the molten glass column 148, helps support bubble ascension through the glass since the velocity at which gas bubbles rise through a glass matrix is inversely proportional to the viscosity of the glass (which is temperature dependent). Moreover, increasing the temperature of the molten glass column 148 and lowering the pressure of the interior fining chamber 156 upsets the gas-phase/melt-phase equilibrium of gases dissolved in the glass matrix and causes degassing. The released gases may diffuse into and enlarge other gas bubbles, which in turn increases the bubble rise velocity of those bubbles. The same general principles apply to the molten glass pool 102 as well.

The outflow of molten glass 26 that is discharged from the glass fining tower 16 through the outlet 164 defined in the tubular wall 122 and then through the exit conduit 162 is preferably drawn from the bottomhalf of the molten glass column 148. The molten glass that comprises the outflow of molten glass 26 is fined, as mentioned above, since enough bubbles have been removed from the glass over the course of its progression from the SC melter 34, through the glass prefining vessel 14, and through the glass fining tower 16. Indeed, as discussed above, the output of unfined molten glass 24 exiting the SC melter 34 has a concentration of entrained gas bubbles that may range from 20 vol % to 60 vol %. The glass prefining vessel 14 removes entrained gas bubbles from the molten glass pool 102 such that the outflow of molten glass 112 that is discharged from the glass prefining vessel 14, as well as inflow of molten glass 168 that is introduced into the glass fining tower 16, has a lower concentration of entrained gas bubbles than the output of unfined molten glass 24 discharged from the SC melter 34. Similarly, the glass fining tower 16 removes entrained bas bubbles from the overspilling glass layer 196 and the molten glass column 148 such that the outflow of molten glass 26 that is discharged from the glass fining tower 16 has a lower concentration of entrained gas bubbles than the inflow of molten glass 168 that is introduced into the glass fining tower 16. As such, and in accordance with the standard recited above, the outflow of molten glass 26 may comprise a bubble count of (i) zero blisters and (ii) less than 0.5 seeds per gram of glass.

After exiting the fining glass tower 16, the outflow of molten glass 26 is supplied to the thermal conditioning tank 18 by way of a glass supply conduit 198. The glass supply conduit 198 does not have to be heated since the molten glass flowing through the conduit 198 is already fined. The input of fined molten glass 28, which is provided by the outflow of molten glass 26 discharged from the glass fining tower 16, is received into the conditioning chamber 184 of the thermal conditioning tank 18 through the inlet 186 of the housing 182. There, the input of fined molten glass 28 combines with the molten glass bath 30 held within the conditioning chamber 184. The molten glass bath 30 flows through the conditioning chamber 184 from the inlet 186 to the outlet 188 of the housing 182 while its temperature is homogenized and steadily reduced in zones by heat from the overhead burners 190 and cooling air. For example, and as discussed above, the molten glass bath 30 may be brought to a glass viscosity at the outlet 188 of the thermal conditioning tank 18 that ranges from 10³ Pa·s to 10² Pa·s, which coincides with a glass temperature that typically ranges from 1050° C. to 1200° C., for soda-lime-silica glass. The output of conditioned molten glass 32 is drawn or pulled from the thermally-homogenized portion of the molten glass bath 30 through the outlet 188 of the housing 182 of the thermal conditioning tank 18 and, thereafter, is supplied to forming equipment such as, for example, a glass container forming machine having a blank mold and a blow mold.

Glass containers may be formed from conditioned molten glass obtained from the output of conditioned molten glass 32 in a forming step 400 as shown in the flow diagram of FIG. 5. In some standard container-forming processes, the output of conditioned molten glass 32 may be discharged from a spout appended to the thermal conditioning tank 18 as conditioned molten glass streams. The conditioned molten glass streams are then sheared into individual gobs of a predetermined weight. Each gob is delivered into a blank mold of a glass container forming machine. In other glass container forming processes, however, the output of conditioned molten glass 32 may be streamed directly from the outlet 188 of the thermal conditioning tank 18 into the blank mold to fill the mold with glass. Once in the blank mold, and with its temperature still between 1050° C. and 1200° C., the conditioned molten glass is pressed or blown in substep 400a into a parison or a partially-formed container that includes a tubular wall. The parison is then transferred from the blank mold into a blow mold of the glass container forming machine. Once the parison is received in the blow mold, the blow mold is closed, and the parison is outwardly blown in substep 400b into a glass container that matches the contour of the mold cavity using a compressed gas such as compressed air. Other approaches may of course be implemented to form the glass containers besides the press-and-blow and blow-and-blow forming techniques including, for instance, compression or other molding techniques.

The glass container formed within the blow mold has an axially closed base and a circumferential wall. The circumferential wall extends from the axially closed base to a mouth that defines an opening to a containment space defined by the axially closed base and the circumferential wall. The glass container is allowed to cool while in contact with the mold walls of the blow mold and is then removed from the blow mold and placed on a conveyor or other transport device. The glass container is then reheated and cooled at a controlled rate in an annealing lehr to relax thermally-induced strain in step 402. The annealing of the glass container involves heating the glass container in substep 402a to a temperature above the annealing point of the soda-lime-silica glass chemical composition, which usually lies within the range of 510° C. to 550° C., followed by slowly cooling the container in substep 402b at a rate of 1° C./min to 10° C./min to a temperature below the strain point of the soda-lime-silica glass chemical composition, which usually lies within the range of 470° C. to 500° C. Any of a variety of coatings may be applied to the surface of the glass container either before (hot-end coatings) or after (cold-end coatings) annealing for any of a variety of reasons.

The glass-producing system 10 or any of its components, as well as the method of operating the system 10 or any of its components, as described above in connection with FIGS. 1-5 may be modified without losing its ability to produce and fine glass in an effective way. Several examples of such modifications are illustrated in FIGS. 6-10 and discussed in more detail below. In each of these various alternate embodiments, only the material difference(s) relative to the previously described embodiment(s) are discussed in further detail; the remainder of the glass-producing system is the same as before and, thus, embodies the teachings and descriptions set forth above with regard to the common structure and function of the system. To that end, the teachings and description set forth above for the various elements of the glass-producing system 10 apply equally to counterpart elements of the alternate embodiments of the glass-producing systems, which are identified by corresponding reference numerals, unless specifically stated otherwise. Other modifications to the glass-producing system 10 and its method of operation not expressly described herein are also possible.

Referring now to FIG. 6, one alternate embodiment of the glass-producing system, which is identified by reference numeral 1010, is depicted. The glass-producing system 1010 shown here includes an SC melter 1034 configured to discharge the output of unfined molten glass 1024 as a plurality of discrete streams 1024a, 1024b of unfined molten glass that falls through the internal fining chamber 1080 of the glass prefining vessel 1014 and combines with the molten glass pool 1102 contained within the glass-holding zone 1098 of the vat 1074. This is different from the output of unfined molten glass 24 that is shown in FIGS. 1-2 of the previous embodiment, which is depicted as a single stream of unfined molten glass. The number of discrete streams that constitute the output of unfined molten glass 1024 may range anywhere from two to ten or, more narrowly, from three to six. By splitting the molten glass in the output of unfined molten glass 1024 into multiple streams of unfined molten glass 1024a, 1024b, the surface area of the output of unfined molten glass 1024 that is exposed to the internal fining chamber 1080 is increased, which may additionally help drive the removal of entrained gas bubbles from the output of unfined molten glass 1024 since more glass surface area is available through which the gas bubbles can escape. The plurality of discrete streams of unfined molten glass 1024a, 1024b can be formed by the flow controller 1060 or by a plate that includes a corresponding number of orifices through which unfined molten glass from the reaction chamber 1040 may traverse when passing through the molten glass outlet 1052 of the melter 1034.

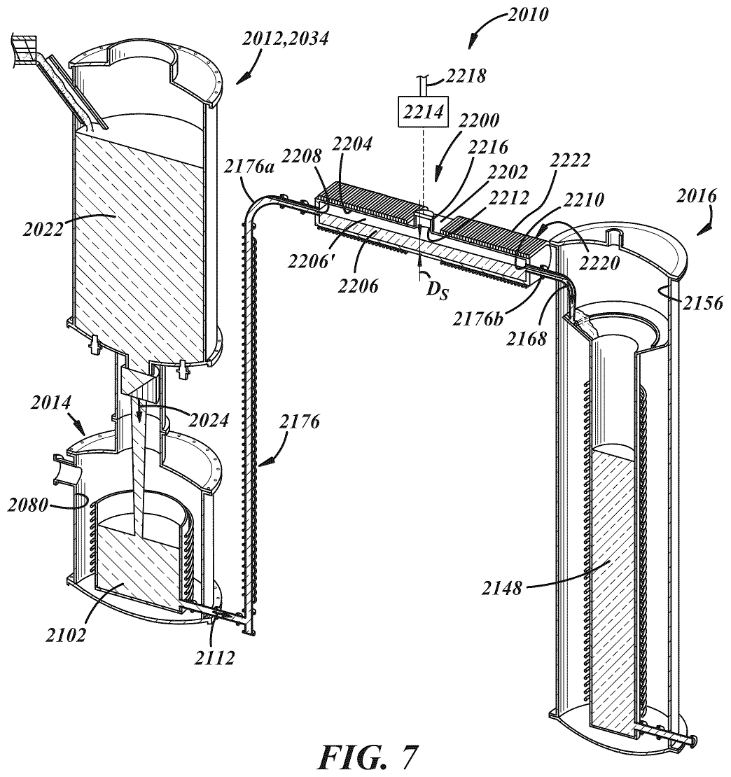

Referring now to FIG. 7, another alternate embodiment of the glass-producing system, which is identified by reference numeral 2010, is depicted. The glass-producing system 2010 shown here includes an intermediate fining reservoir 2200 located in the glass transfer conduit 2176 that supplies the glass fining tower 2016 with the inflow of molten glass 2168. The intermediate fining reservoir 2200 includes a housing 2202 that defines an internal fining chamber 2204 where a sheet of molten glass 2206 is contained. The molten glass sheet 2206 is shallow in that a ratio of a depth D_{S} of the molten glass sheet 2206 (in meters) to a surface area of a top surface 2206′ of the molten glass sheet 2206 (in meters squared) is less than 5% or, more preferably, less than 3%. The relatively high surface area of the molten glass sheet 2206, and its relatively shallow depth D_{S}, helps encourage the removal of entrained gas bubbles by limiting the distance the gas bubbles must rise through the molten glass before escaping the glass and bursting, thus accomplishing some additional, intermediate fining between the glass prefining vessel 2014 and the glass fining tower 2016.

An inlet 2208, an outlet 2210, and a vacuum port 2212 are defined in the housing 2202 of the intermediate fining reservoir 2200. The inlet 2208 and the outlet 2210 are defined in the housing 2202 and allow the intermediate fining reservoir 2200 to be connected to the glass transfer conduit 2176. Specifically, an upstream portion 2176a of the glass transfer conduit 2176 connects the inlet 2208 to the glass prefining vessel 2014 and a downstream portion 2176b of the glass transfer conduit 2176 connects the outlet 2210 to the glass fining tower 2016. The vacuum port 2212 is fluidly connected to a vacuum source 2214, such a positive displacement pump or a momentum transfer pump, by way of a vacuum conduit 2216. The vacuum source 2214 is operable to reduce a pressure of the internal fining chamber 2204 to a subatmospheric level. For instance, as before, the vacuum source 2214 may be operated to bring and maintain the pressure, measured as absolute pressure, within the internal fining chamber 2204 to anywhere between 5 torr and 750 torr. The vacuum conduit 2216 may also fluidly communicate with an exhaust conduit 2218 so that any gaseous compounds removed from the internal fining chamber 2204 can be directed away from the intermediate fining reservoir 2200 for appropriate downstream management. Moreover, a heater 2220—such as an induction heater that may be constructed the same as the induction heaters described above in that it includes one or more induction heating coils 2222 disposed around the housing 2202 of the intermediate fining reservoir 2200—is operable to introduce heat into the molten glass sheet 2206. The heater 2220, in operation, can be controlled to heat the molten glass sheet 2206 to a temperature that ranges anywhere from 1250° C. to 1700° C.

In use, the outflow of molten glass 2112 that is discharged from the glass prefining vessel 2014 flows through the upstream portion 2176a of the glass transfer conduit 2176 and is introduced into the internal fining chamber 2204 through the inlet 2208. The outflow of molten glass 2112 combines with and spreads out into the molten glass sheet 2206. The molten glass sheet 2206 flows from the inlet 2208 to the outlet 2210 and, ultimately, the inflow of molten glass 2168 that is introduced into the interior fining chamber 2156 of the glass fining tower 2016 is removed from the outlet 2210 and flows through the downstream portion 2176b of the glass transport conduit 2176 to the glass fining tower 2016. Because of the fining that occurs in the intermediate fining reservoir 2200, the inflow of molten glass 2168 that is delivered to the glass fining tower 2016 may have a lower concentration of entrained gas bubbles than the outflow of molten glass 2112 that is discharged from the glass prefining vessel 2014. To aid in the fining capability of the intermediate fining reservoir 2200, the pressure of the interior fining chamber 2204 may be maintained between 5 torr and 750 torr or, more narrowly, between 100 torr and 400 torr, and the temperature of the molten glass sheet 2206 may be maintained at a temperature ranging from 1250° C. to 1700° C. or, more narrowly, from 1250° C. to 1650° C. or even from 1350C° to 1550° C. The pressure in the interior fining chamber 2204 of the intermediate fining reservoir 2200 is preferably less than the pressure of the internal fining chamber 2080 of the glass prefining vessel 2014 but greater than the pressure of the interior fining chamber 2156 of the glass fining tower 2016.

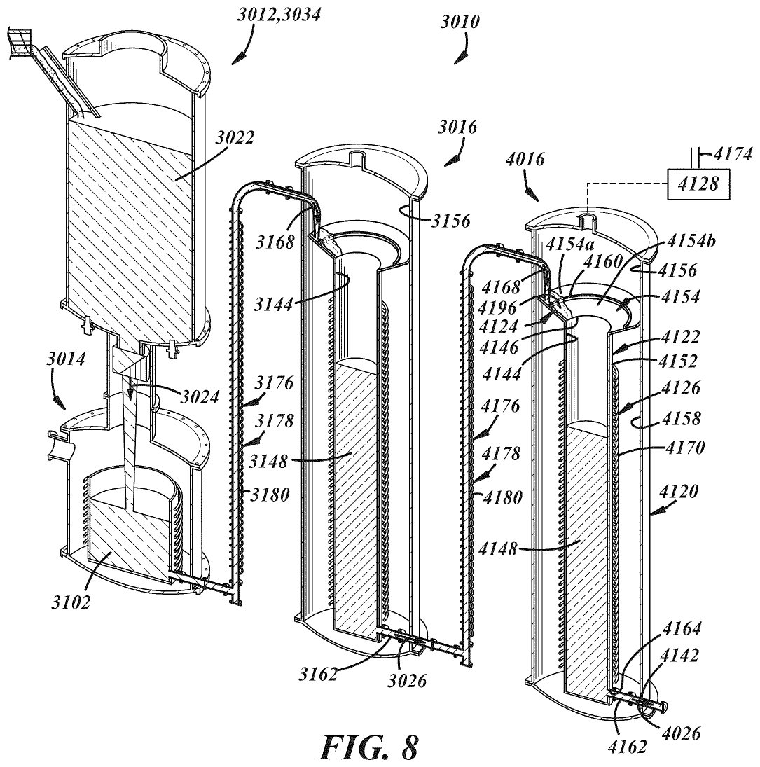

Referring now to FIG. 8, another alternate embodiment of the glass-producing system, which is identified by reference numeral 3010, is depicted. The glass-producing system 3010 shown here includes two glass fining towers 3016, 4016. The glass fining tower 3016 that is closest to the SC melter 3034 in terms of its position along the flow direction through the glass-producing system 3010 is referred to as the “first glass fining tower” and the additional glass fining tower 4016 located downstream of the first glass fining tower 3016 along the flow direction through the system 3010 is referred to as the “second glass fining tower.” The additional, second glass fining tower 4016 may be employed downstream of the first glass fining tower 3016 if the outflow of molten glass 3026 discharged from the first fining tower 3016 is comprised of molten glass that does not yet satisfy the applicable standard for fined molten glass. The first glass fining tower 3016 and the second glass fining tower 4016 are fluidly connected by a glass transport conduit 4176 (hereafter the “second glass transport conduit”) that may have the same construction and function as the glass transport conduit 3176 (hereafter the “first glass transport conduit”) that fluidly connects the glass prefining vessel 3014 and the first glass fining tower 3016. The second glass fining tower 4016 may, as shown here, have the same construction and operability as the first glass fining tower 3016, although that is not necessarily required.

The second glass fining tower 4016 performs the additional fining that is needed downstream of the first glass fining tower 3016 to achieve fined molten glass. In that regard, the outflow of molten glass 3026 discharged from the first glass fining tower 3016 is not delivered to the thermal conditioning tank, as shown in FIGS. 1-4, but, rather, flows into the second glass transport conduit 4176 and is conveyed to the second glass fining tower 4016. The outflow of molten glass 3026 thus serves as the inflow of molten glass 4168 that is received in the interior fining chamber 4156 of the second glass fining tower 4016, which is preferably maintained at a subatmospheric pressure that is lower than the pressure maintained in the interior fining chamber 3156 of the first glass fining tower 3016. And, similar to the first glass fining tower 3016, the inflow of molten glass 4168 is introduced into the interior fining chamber 4156 of the second glass fining tower 4016 onto the base receiving wall 4124 and flows over the base receiving wall 4124 into the elongated vertical well 4144. In particular, the inflow of molten glass 4168 is poured onto the outer portion 4154a of the glass distribution surface 4154 where is spreads out behind the protruding lip 4160 and around the opening 4146 of the elongated vertical well 4144 as an overspilling glass layer 4196, thus invoking thin-layer fining. The overspilling glass layer 4196 flows over the protruding lip 4160 and inward across the inner portion 4154b of the glass distribution surface 4154 and, eventually, pours into the elongated vertical well 4144, thus invoking stream fining. Additional deep gravitational fining proceeds in most cases to occur in the molten glass column 4148 while heat is being introduced into the molten glass column 4148 by the heater 4126, which, as before, may be an induction heater having the same construction as described above or it may be another type of heater such as an electric heater, a microwave heater, or a combustion heater.

The outflow of molten glass 4026 that is discharged from the second glass fining tower 4016 through the outlet 4164 defined in the tubular wall 4122 and then through the exit conduit 4162 is preferably drawn from the bottomhalf of the molten glass column 4148. The molten glass that comprises the outflow of molten glass 4026 is fined since, here, enough bubbles have been removed from the glass over the course of its progression from the SC melter 3034, through the glass prefining vessel 3014, through the first glass fining tower 3016, and finally through the second glass fining tower 4016. And, as a consequence of the second glass fining tower 4016 removing entrained bas bubbles from the molten glass column 4148, the outflow of molten glass 4026 that is discharged from the second glass fining tower 4016 has a lower concentration of entrained gas bubbles than the outflow of molten glass 3026 discharged from the first glass fining tower 3016 as well as the inflow of molten glass 4168 that is introduced into the second glass fining tower 4016. The outflow of molten glass 4026 drawn from the second glass fining tower 4016 may be comprised of fined glass in accordance with the standard recited above—that is, the outflow of molten glass 4026 may comprise a bubble count of (i) zero blisters and (ii) less than 0.5 seeds per gram of glass. After exiting the fining glass vessel 4016, the outflow of molten glass 4026 is supplied to the thermal conditioning tank (not shown in FIG. 8) by way of the glass supply conduit 198.

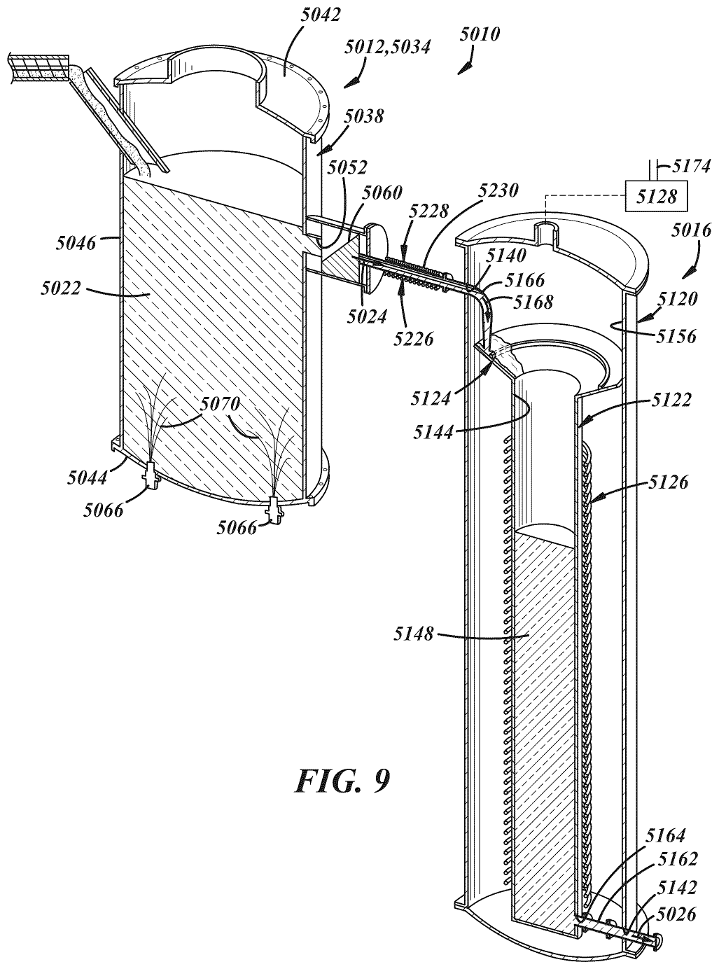

Referring now to FIG. 9, another alternate embodiment of the glass-producing system, which is identified by reference numeral 5010, is depicted. The glass-producing system 5010 shown here omits the glass prefining vessel 14, 1014, 2014, 3014 included in the other embodiments of the glass-producing system 10, 1010, 2010, 3010 described above. The glass fining tower 5016 may be used in the absence of the glass prefining vessel 14, 1014, 2014, 3014 when, for example, the concentration of entrained gas bubbles in the output of unfined molten glass 5024 is more moderate and/or when the fining capability of the glass fining tower 5016, due to its size or process conditions or other factors, obviates the need for the glass prefining vessel 14, 1014, 2014, 3014. In this particular embodiment, the molten glass outlet 5052 may be defined in the upstanding wall 5046 of the housing 5038 to provide a side discharge configuration as opposed to a bottom discharge configuration. The molten glass outlet 5052 may be defined in any portion of the upstanding wall 5046 that is immersed by the agitated glass melt 5022 and, if desired, a flow controller 5060 may be coupled to the molten glass outlet 5052 to control the flow rate of the output of unfined molten glass 5024 from the SC melter 5034.

The SC melter 5034 and the glass fining tower 5016 are fluidly connected by a glass transfer conduit 5226 that transfers molten glass between the two units 5034, 5016. The glass transfer conduit 5226 may have the same construction and function as the glass transport conduit 176 shown in FIG. 1 and, as such, a heater 5228—such as an induction heater that includes one or more induction heating coils 5230 disposed around the glass transfer conduit 5226—may be thermally interconnected to the glass transfer conduit 5226. The heater 5228, in operation, can be controlled to maintain the molten glass within the glass transfer conduit 5226 at a temperature that ranges anywhere from 1250° C. to 1700° C. The glass transfer conduit 5226 is connected at one end to the flow controller 5060, as shown, although it could also be connected directly to the molten glass outlet 5052, and is connected at the other end to the inlet opening 5140 of the shell 5120 that communicates with the inlet conduit 5166. To that end, the output of unfined molten glass 5024 that is drawn from the agitated glass melt 5022 and discharged from the SC melter 5034 is conveyed to the glass fining tower 5016 by the glass transfer conduit 5226 and serves as the inflow of molten glass 5168 that is received in the interior fining chamber 5156 of the glass fining tower 5016.

The inflow of molten glass 5168 is introduced into the interior fining chamber 5156 onto the base receiving wall 5124 and flows over the base receiving wall 5124 into the elongated vertical well 5144, as previously described, to thereby invoke both thin-layer fining and stream fining. Deep gravitational fining may also occur in the molten glass column 5148 while heat is being introduced into the molten glass column 5148 by the heater 5126. And, for all of the reasons discussed above, the interior fining chamber 5156 is maintained at a subatmospheric pressure. The outflow of molten glass 5026 that is discharged from the glass fining tower 5016 through the outlet 5164 defined in the tubular wall 5122 and then through the exit conduit 5162 is preferably drawn from the bottomhalf of the molten glass column 5148. The molten glass that comprises the outflow of molten glass 5026 is fined since enough bubbles have been removed from the glass over the course of its progression from the SC melter 5034 and then through the glass fining tower 5016. As such, the outflow of molten glass 5026 that is discharged from the glass fining tower 5016 has a lower concentration of entrained gas bubbles than the inflow of molten glass 5168 that is introduced into the glass fining tower 5016. The outflow of molten glass 5026 is then supplied to the thermal conditioning tank (not shown here) by way of the glass supply conduit 198.

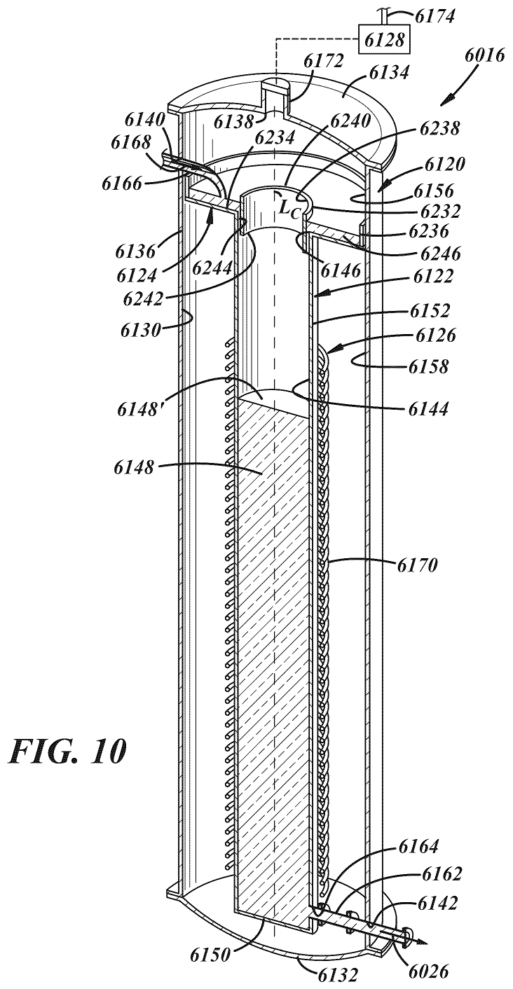

Referring now to FIG. 10, an alternate embodiment of the glass fining tower, which is identified by reference numeral 6016, is depicted. The glass fining tower 6016 of this embodiment is the same as the glass fining tower 16 shown in FIGS. 1 and 3 with the exception that the base receiving wall 6124 is constructed differently and a sleeve 6232 is included within the elongated vertical well 6144 defined by the tubular wall 6122. Here, the base receiving wall 6124 extends inwardly from the shell 6120 and, in particular, the elongated sidewall 6136, to the tubular wall 6122 to provide a glass distribution surface 6234 that at least partially surrounds the opening 6146 of the elongated vertical well 6144. The base receiving wall 6124 includes a vertical perimeter flange 6236 that abuts the shell 6120 and the glass distribution surface 6234 extends inwardly from the vertical flange 6236. The glass distribution surface 6234 may extend inwardly perpendicular to the longitudinal centerline L_{C} of the shell 6120, as shown, or it may taper downwardly from the shell 6120 to the opening 6146 of the elongated vertical well 6144. The sleeve 6232 is supported within the elongated vertical well 6144 by the tubular wall 6122 such as, for example, by cross-members that intermittently extend between the two structures 6122, 6232. The sleeve 6232 is a hollow shaft that defines a central duct 6238. Moreover, as shown, the sleeve 6232 extends through the opening 6146 between a top end 6240, which is disposed above the glass distribution surface 6234 in the interior fining chamber 6156, and a bottom end 6242, which is disposed within the elongated vertical well 6144.

The sleeve 6232 and tubular wall 6122 define a boundary passage 6244 therebetween within the elongated vertical well 6144. The boundary passage 6244 is restrictive enough that the inflow of molten glass 6168, when introduced onto the glass distribution surface 6234, spreads out to form the overspilling glass layer 6246, thus invoking thin-layer fining, without needing to include a protruding lip around the opening 6146 of the elongated vertical well 6144. The overspilling glass layer 6246 then flows downwardly into the elongated vertical well 6144 through the boundary passage 6244, thus invoking stream fining. Should the overspilling glass layer 6246 become too thick, the glass layer 6246 may flow into the elongated vertical well 6144 and combine with the molten glass column 6148 by flowing over the top end 6240 of the sleeve 6232 and down through the central duct 6238 in addition to flowing around the outside of the sleeve 6232 down through the boundary passage 6244. The molten glass column 6148 is preferably fed by the overspilling glass layer 6246 and, additionally, deep gravitational fining may occur in the molten glass column 6148 while heat is being introduced into the molten glass column 6148 by the heater 6126. Again, as before, the interior fining chamber 6156 is maintained at a subatmospheric pressure to promote bubble rise and release as described above. The outflow of molten glass 6026 that is discharged from the glass fining tower 6016 through the outlet 6164 defined in the tubular wall 6122 and then through the exit conduit 6162 is preferably drawn from the bottomhalf of the molten glass column 6148. The outflow of molten glass 6026 that is discharged from the glass fining tower 6016 has a lower concentration of entrained gas bubbles than the inflow of molten glass 6168 that is introduced into the glass fining tower 6016. And, if the molten glass that comprises the outflow of molten glass 6026 is fined, the outflow of molten glass 6026 may be conditioned and then delivered to forming equipment as described above.

A number of alternate embodiments of the glass-producing system 1010, 2010, 2010, 5010 as well as an alternate embodiment of the glass fining tower 6016 have been described. These various alternate embodiments may be combined with each other. For example, the SC melter 2034, 3034 in each of the embodiments of the glass-producing systems 2010, 3010 shown in FIGS. 7-8 may, if desired, be configured to discharge the output of unfined molten glass 2024, 3024 as a plurality of discrete streams of unfined molten glass as shown in the glass-producing system 1010 depicted in FIG. 6. As another example, any of the glass transport conduits 3176, 4176, 5226 included in the embodiments of the glass-producing systems 3010, 5010 shown in FIGS. 8-9 may, if desired, include an intermediate fining reservoir as shown in the glass-producing system 2010 depicted in FIG. 7. Still further, as another example, the glass-producing system 5010 shown in FIG. 9 may include an additional, second glass fining tower downstream of the glass fining tower 5016 that is connected to the SC melter 5034 relative to the flow direction of glass through the glass-producing system 5010 as shown in FIG. 8. And, in yet another example, the glass fining tower 6016 shown in FIG. 10 may be substituted, if desired, for any of the glass fining towers 16, 1016, 2016, 3016, 4016, 5016 depicted in the embodiments of the glass-producing systems 10, 1010, 2010, 3010, 5010 shown in FIGS. 1, 3, and 7-9.

There thus has been disclosed a glass-producing system, which includes at least one glass fining tower, and a method for producing glass with the system that satisfies one or more of the objects and aims previously set forth. The disclosure has been presented in conjunction with several illustrative embodiments, and additional modifications and variations have been discussed. Other modifications and variations readily will suggest themselves to persons of ordinary skill in the art in view of the foregoing discussion. The disclosure is intended to embrace all such modifications and variations as fall within the spirit and broad scope of the appended claims.

1. A glass-producing system comprising:
a glass melter; and
a glass fining tower positioned downstream of the glass melter relative to a flow direction of glass through the glass-producing system, the glass fining tower comprising:
a shell;
a tubular wall disposed within and surrounded by the shell;
a base receiving wall that extends inwardly from the shell to the tubular wall, the tubular wall and the base receiving wall providing an interior fining chamber within the shell, the interior fining chamber comprising an elongated vertical well, the elongated vertical well being defined by the tubular wall and having an opening that is at least partially surrounded by a glass distribution surface of the base receiving wall;
a heater operable to introduce heat through the tubular wall; and
a vacuum source operable to reduce a pressure of the interior fining chamber to a subatmospheric level.

2. The glass-producing system set forth in claim 1, wherein the glass fining tower is configured to deliver an inflow of molten glass onto the base receiving wall so that the inflow of molten glass flows over the glass distribution surface into the elongated vertical well to feed a column of molten glass contained in the elongated vertical well, and wherein the glass fining tower is further configured to discharge an outflow of molten glass that is drawn from the column of molten glass contained in the elongated vertical well.

3. The glass-producing system set forth in claim 1, wherein the glass melter is a submerged combustion melter that includes one or more submerged burners.

4. The glass-producing system set forth in claim 1, wherein an output of unfined molten glass that comprises at least 20 vol % of entrained gas bubbles is discharged from the glass melter.

5. The glass-producing system set forth in claim 1, wherein the glass distribution surface of the base receiving wall tapers downwardly to the opening of the elongated vertical well and additionally defines a protruding lip that surrounds the opening of the elongated vertical well and separates the glass distribution surface into an outer portion that lies adjacent to the shell and an inner portion that lies adjacent to the opening of the elongated vertical well.

6. The glass-producing system set forth in claim 5, wherein the glass fining tower comprises an inlet conduit that extends into the interior fining chamber and terminates above the outer portion of the glass distribution surface such that the inflow of molten glass is poured onto the outer portion of the glass distribution surface upon being introduced into the glass fining tower.

7. The glass-producing system set forth in claim 1, wherein a sleeve is supported within the elongated vertical well, the sleeve extending through the opening of the elongated vertical well between a top end disposed above the glass distribution surface and a bottom end disposed within the elongated vertical well, the sleeve and the tubular wall defining a boundary passage therebetween.

8. The glass-producing system set forth in claim 1, wherein the glass melter includes a housing having a roof, a floor, and an upstanding wall that connects the roof and the floor, and wherein a molten glass outlet is defined in the floor of the housing, the glass-producing system further comprising:
a glass prefining vessel located beneath the glass melter, the glass prefining vessel comprising a shell that defines an internal fining chamber and a vat that is enclosed by the shell, the shell being connected to the housing of the glass melter around the molten glass outlet, and the vat including a drum wall that defines a glass-holding zone within the internal fining chamber of the glass prefining vessel beneath the molten glass outlet of the glass melter.

9. The glass-producing system set forth in claim 8, wherein the glass fining tower is positioned downstream of the glass prefining vessel relative to the flow direction of glass through the glass-producing system, and wherein the glass prefining vessel and the glass fining tower are fluidly connected by a glass transfer conduit that is thermally interconnected to a heater so that heat can be introduced into molten glass traveling between the glass prefining vessel and the glass fining tower within the glass transfer conduit.

10. The glass-producing system set forth in claim 9, further comprising an intermediate fining reservoir located within the glass transfer conduit, the intermediate fining reservoir including a housing that defines an internal fining chamber, the intermediate fining reservoir further having an inlet and an outlet, and wherein the inlet is connected to the glass prefining vessel by an upstream portion of the glass transfer conduit and the outlet is connected to the glass fining tower by a downstream portion of the glass transfer conduit.

11. The glass-producing system set forth in claim 1, wherein the glass melter and the glass fining tower are fluidly connected by a glass transfer conduit.

12. The glass-producing system set forth in claim 11, further comprising an intermediate fining reservoir located within the glass transfer conduit, the intermediate fining reservoir having a housing that defines an internal fining chamber and further including an inlet and an outlet, and wherein the inlet is connected to the glass melter by an upstream portion of the glass transfer conduit and the outlet is connected to the glass fining tower by a downstream portion of the glass transfer conduit.

13. The glass-producing system set forth in claim 1, wherein an outlet of the tubular wall fluidly communicates with an exit conduit that extends outwardly from the tubular wall through an exit opening in the shell of the glass fining tower.

14. The glass-producing system set forth in claim 1, wherein an additional, second glass fining tower is positioned downstream of the glass fining tower relative to the flow direction of glass through the glass-producing system, the second glass fining tower comprising:
a shell;
a tubular wall disposed within and surrounded by the shell of the second glass fining tower;
a base receiving wall that extends inwardly from the shell of the second glass fining tower to the tubular wall of the second glass fining tower, the tubular wall of the second glass fining tower and the base receiving wall of the second glass fining tower providing an interior fining chamber, the interior fining chamber of the second glass fining tower comprising an elongated vertical well, the elongated vertical well of the interior fining chamber of the second glass fining tower being defined by the tubular wall of the second glass fining tower and having an opening that is at least partially surrounded by a glass distribution surface of the base receiving wall of the second glass fining tower;
a heater operable to introduce heat through the tubular wall of the second glass fining tower; and
a vacuum source operable to reduce a pressure of the interior fining chamber of the second glass fining tower to a subatmospheric level;
wherein the glass fining tower and the second glass fining tower are fluidly connected by a glass transfer conduit.

15. The glass-producing system set forth in claim 1, further comprising:
a thermal conditioning tank positioned downstream of the glass fining tower relative to the flow direction of glass through the glass-producing system.

16. A glass-producing system comprising:
a glass melter from which an output of unfined molten glass is discharged; and
a glass fining tower positioned downstream of the glass melter relative to a flow direction of glass through the glass-producing system, the glass fining tower comprising:
a shell;
a tubular wall disposed within and surrounded by the shell, the tubular wall defining an elongated vertical well that contains a column of molten glass;
a base receiving wall that extends inwardly from the shell to the tubular wall and provides a glass distribution surface that at least partially surrounds an opening of the elongated vertical well, the base receiving wall and the tubular wall together establishing an interior fining chamber within the shell of which the elongated vertical well is part;
a heater operable to introduce heat into the molten glass column through the tubular wall; and
a vacuum source that fluidly communicates with a vacuum port defined in the shell and is operable to reduce a pressure of the interior fining chamber to a subatmospheric level;
wherein the glass fining tower is configured to deliver an inflow of molten glass onto the base receiving wall so that the inflow of molten glass flows over the glass distribution surface into the elongated vertical well to feed the column of molten glass contained in the elongated vertical well, and wherein the glass fining tower is further configured to discharge an outflow of molten glass that is drawn from the column of molten glass contained in the elongated vertical well.

17. The glass-producing system set forth in claim 16, wherein the glass melter is a submerged combustion melter that includes one or more submerged burners, and wherein the output of unfined molten glass comprises at least 20 vol % of entrained gas bubbles.

18. The glass-producing system set forth in claim 16, wherein the glass distribution surface of the base receiving wall tapers downwardly to the opening of the elongated vertical well and additionally defines a protruding lip that surrounds the opening of the elongated vertical well and separates the glass distribution surface into an outer portion that lies adjacent to the shell and an inner portion that lies adjacent to the opening of the elongated vertical well.

19. The glass-producing system set forth in claim 16, wherein a sleeve is supported within the elongated vertical well, the sleeve extending through the opening of the elongated vertical well between a top end disposed above the glass distribution surface and a bottom end disposed within the elongated vertical well, the sleeve and the tubular wall defining a boundary passage therebetween.

20. A method of producing glass, the method comprising:
discharging an output of unfined molten glass from a glass melter, the output of unfined molten glass comprising at least 20 vol % of entrained gas bubbles;
introducing an inflow of molten glass, which is sourced from the output of unfined molten glass discharged from the glass melter, into a glass fining tower, the glass fining tower comprising a shell, a tubular wall disposed within and surrounded by the shell, and a base receiving wall that extends inwardly from the shell to the tubular wall, the tubular wall and the base receiving wall providing an interior fining chamber within the shell, wherein the tubular wall defines an elongated vertical well, which is part of the interior fining chamber and contains a column of molten glass, and wherein the base receiving wall provides a glass distribution surface that at least partially surrounds an opening of the elongated vertical well;
delivering the inflow of molten glass onto the base receiving wall and flowing the inflow of molten glass over the glass distribution surface of the base receiving wall as an overspilling glass layer that falls into the elongated vertical well and combines with the column of molten glass;
maintaining a subatmospheric pressure within the interior fining chamber of the glass fining tower;
introducing heat into the molten glass column contained within the elongated vertical well through the tubular wall; and
discharging an outflow of molten glass, which is drawn from the column of molten glass contained within the elongated vertical well, from the glass fining tower, the outflow of molten glass having a concentration of entrained gas bubbles that is lower than a concentration of entrained gas bubbles of the inflow of molten glass.

21. The method set forth in claim 20, wherein discharging an output of molten glass from the glass fining tower comprises drawing the output of molten glass from a bottomhalf of the column of molten glass contained within the elongated vertical well, and wherein the output of molten glass comprises fined molten glass that has a bubble count of (i) zero blisters and (ii) less than 0.5 seeds per gram of glass.
